(19) United States
(12) Patent Application Publication
(10) Pub. No.: US 2014/0337633 A1
(43) Pub. Date: Nov. 13, 2014

(54) System and Method for Indicating a Service Set Identifier

(71) Applicant: Futurewei Technologies, Inc., Plano, TX (US)

(72) Inventors: Yunsong Yang, San Diego, CA (US); Young Hoon Kwon, San Diego, CA (US); Zhigang Rong, San Diego, CA (US)

(73) Assignee: Futurewei Technologies, Inc., Plano, TX (US)

(21) Appl. No.: 14/272,004

(22) Filed: May 7, 2014

Related U.S. Application Data
(60) Provisional application No. 61/820,228, filed on May 7, 2013.

(51) Int. Cl. H04W 12/08; H04L 9/32

(52) U.S. Cl. CPC H04W 12/08; H04L 9/3297
USPC 713/178

(57) ABSTRACT

A method for securing communications between an access point and a station includes generating a first hashed service set identifier (SSID) by applying a first hash function to a first SSID known by the station, transmitting a first message to the access point, wherein the first message includes the first hashed SSID, and receiving a second message from the access point, wherein the second message includes a second hashed SSID generated by the access point by applying a second hash function to a second SSID associated with the access point. The method also includes generating a third hashed SSID by applying the second hash function to the first SSID, determining if the third hashed SSID matches the second hashed SSID, and transmitting a third message to the access point if the third hashed SSID matches the second hashed SSID.

This application claims the benefit of U.S. Provisional Application No. 61/820,228, filed on May 7, 2013, entitled “Method and System for Indicating a Service Set Identifier,” which application is hereby incorporated herein by reference.

### TECHNICAL FIELD

The present disclosure relates generally to digital communications, and more particularly to a system and method for indicating a service set identifier (SSID).

### BACKGROUND

A wireless LAN (WLAN) or Wi-Fi (wireless-fidelity) communication system may include an access point (AP) and one or more stations (STAs), which the AP serves. An AP may also be referred as a communications controller, base station, access node, and the like. A STA may also be referred as a client device, device, terminal, mobile station, user equipment, and the like. Today, typical examples of WLAN STAs may be found in laptops, smart-phones, tablets, sensors, and so on.

### SUMMARY OF THE DISCLOSURE

Example embodiments of the present disclosure which provide a system and method for indicating a service set identifier (SSID).

In accordance with an example embodiment of the present disclosure, a method for securing communications between an access point and a station is provided. The method includes generating, by the station, a first hashed service set identifier (SSID) by applying a first hash function to a first SSID known by the station, transmitting, by the station, a first message to the access point, wherein the first message includes the first hashed SSID, and receiving, by the station, a second message from the access point, wherein the second message includes a second hashed SSID generated by the access point by applying a second hash function to a second SSID associated with the access point. The method also includes generating, by the station, a third hashed SSID by applying the second hash function to the first SSID, determining, by the station, if the third hashed SSID matches the second hashed SSID, and transmitting, by the station, a third message to the access point if the third hashed SSID matches the second hashed SSID.

In accordance with another example embodiment of the present disclosure, a method for securing communications between an access point and a station is provided. The method receiving, by the station, a first message from the access point, wherein the first message includes a first hashed service set identifier (SSID) generated by applying a first hash function to a first SSID associated with the access point, and generating, by the station, a second hashed SSID by applying the first hash function to a second SSID known by the station. The method also includes determining, by the station, if the second hashed SSID matches the first hashed SSID, and transmitting, by the station, a second message to the access point if the second hashed SSID matches the first hashed SSID.

In accordance with another example embodiment of the present disclosure, a method for securing communications between an access point and a station is provided. The method includes generating, by the access point, a first hashed service set identifier (SSID) by applying a first hash function to a first SSID associated with the access point, and transmitting, by the access point, a Beacon frame to the station, wherein the Beacon frame includes the first hashed SSID. The method also includes receiving, by the access point, a first message from the station, and transmitting, by the access point, a second message to the station, wherein the second message is responsive to the first message.

In accordance with another example embodiment of the present disclosure, a station is provided. The station includes a processor, a transmitter operatively coupled to the processor, and a receiver operatively coupled to the processor. The processor generates a first hashed service set identifier (SSID) by applying a first hash function to a first SSID known by the station, generates a third hashed SSID by applying a second hash function to the first SSID, and determines if the third hashed SSID matches a second hashed SSID generated by an access point by applying the second hash function to a second SSID associated with the access point. The transmitter transmits a first message to the access point, wherein the first message includes the first hashed SSID, and transmits a third message to the access point if the third hashed SSID matches the second hashed SSID. The receiver receives a second message from the access point, wherein the second message includes the second hashed SSID.

In accordance with another example embodiment of the present disclosure, an access point is provided. The access point includes a processor, a transmitter operatively coupled to the processor, and a receiver operatively coupled to the processor. The processor generates a first hashed service set identifier (SSID) by applying a first hash function to a first SSID associated with the access point. The transmitter transmits a Beacon frame to a station, wherein the Beacon frame includes the first hashed SSID, and transmits a second message to the station, wherein the second message is responsive to a first message from the station. The receiver receives the first message.

In accordance with another example embodiment of the present disclosure, a communications system is provided. The communications system includes an access point, and a station operatively coupled to the access point. The access point serves stations operating within a coverage area. The station generates a first hashed service set identifier (SSID) by applying a first hash function to a first SSID known by the station, transmits a first message to the access point, wherein the first message includes the first hashed SSID, receives a second message from the access point, wherein the second message includes a second hashed SSID generated by the access point by applying a second hash function to a second SSID associated with the access point, generates a third hashed SSID by applying the second hash function to the first SSID, determines if the third hashed SSID matches the second hashed SSID, and transmits a third message to the access point if the third hashed SSID matches the second hashed SSID.

One advantage of an embodiment is that the SSID of an AP is kept hidden from hackers, thereby possibly preventing a variety of hack attacks on the AP and STAs served by the AP.

A further advantage of an embodiment is that the privacy of end users of STAs served by an AP utilizing the example embodiments disclosed herein is preserved. The maintenance of the privacy of the end users may help prevent the tracking of the end users, the inference of relationships between the end users, and the like.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2 illustrates an example diagram illustrating messages exchanged between communicating devices as a station connects with an access point;

FIGS. 3a and 3b illustrate example hashed SSID generators according to example embodiments described herein;

FIGS. 4a and 4b illustrate example hashed SSID generators that generate legacy SSID IE compliant hashed SSIDs according to example embodiments described herein;

FIG. 5a illustrates a first example hashed SSID IE according to example embodiments described herein;

FIG. 5b illustrates a second example hashed SSID IE according to example embodiments described herein;

FIGS. 5c and 5d illustrate example legacy SSID IEs with legacy SSID field support for hashed SSIDs according to example embodiments described herein;

FIG. 6 illustrates a message exchange diagram of example messages exchanged between a STA and an AP as the STA connects with the AP according to example embodiments described herein;

FIG. 7a illustrates a flow diagram of example operations occurring in a STA as the STA connects to an AP using a passive scanning procedure according to example embodiments described herein;

FIG. 7b illustrates a flow diagram of example operations occurring in an AP as a STA connects to the AP using a passive scanning procedure according to example embodiments described herein;

FIG. 8a illustrates a flow diagram of example operations occurring in a STA as the STA connects to an AP using a combination of passive and active scanning procedures according to example embodiments described herein;

FIG. 8b illustrates a flow diagram of example operations occurring in an AP as a STA connects to the AP using a combination of passive and active scanning procedures according to example embodiments described herein;

FIG. 9a illustrates a flow diagram of example operations occurring in a STA as the STA connects to an AP using an active scanning procedure according to example embodiments described herein;

FIG. 9b illustrates a flow diagram of example operations occurring in an AP as a STA connects to the AP using an active scanning procedure according to example embodiments described herein;

FIG. 10 illustrates a message exchange diagram of example messages exchanged between a STA, an AP, and a legacy AP as the STA connects with the AP according to example embodiments described herein; and

FIG. 11 illustrates an example communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to indicating SSIDs. For example, a station generates a first hashed service set identifier (SSID) by applying a first hash function to a first SSID known by the station, transmits a first message to an access point, wherein the first message includes the first hashed SSID, and receives a second message from the access point, wherein the second message includes a second hashed SSID generated by the access point by applying a second hash function to a second SSID associated with the access point. The station also generates a third hashed SSID by applying the second hash function to the first SSID, determines if the third hashed SSID matches the second hashed SSID, and transmits a third message to the access point if the third hashed SSID matches the second hashed SSID.

The present disclosure will be described with respect to example embodiments in a specific context, namely communications systems that use an identifier of a communications controller to facilitate control operations such as scanning, association, reassociation, authentication, and the like. The disclosure may be applied to standards compliant communications systems, such as those that are compliant with Third Generation Partnership Project (3GPP), IEEE 802.11, and the like, technical standards, and non-standards compliant communications systems, that use identifiers of communications controllers to facilitate control operations.

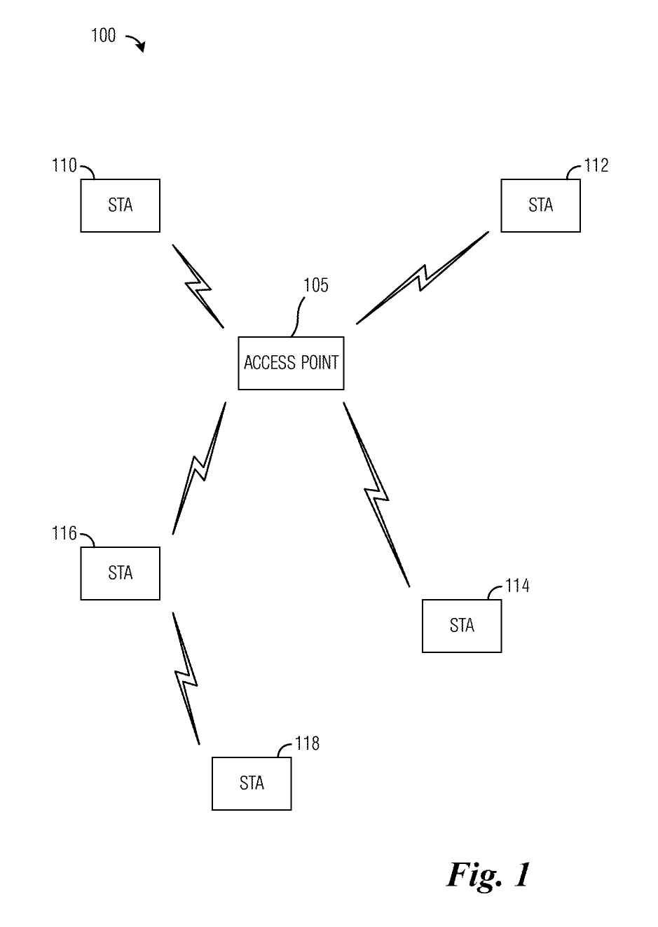

FIG. 1 illustrates an example communications system 100. Communications system 100 includes an access point (AP) 105 that serves one or more stations, such as stations (STA) 110-116, by receiving communications originating from the stations and then forwarding the communications to their intended destinations or receiving communications destined to the stations and then forwarding the communications to their intended stations. In addition to communicating through AP 105, some stations may directly communicate with one another. As an illustrative example, station 116 may transmit directly to station 118. APs may also be commonly referred to as NodeBs, evolved NodeBs (eNBs), base stations, controllers, communications controllers, and the like. Stations may also be commonly referred to as mobile stations, mobiles, user equipment (UE), terminals, users, subscribers, and the like.

While it is understood that communications systems may employ multiple APs capable of communicating with a number of stations, only one AP, and a number of stations are illustrated for simplicity.

APs are configured with a service set identifier (SSID) for a variety of purposes, including WLAN discovery. An AP may broadcast its SSID in Beacon frames to announce its presence. A client device (or STA) may display received SSIDs to show an available WLAN list to an end user. As a result, for example, the end user may choose to add an AP to a preferred WLAN list. Afterwards, the client device may automatically search for the preferred AP(s) using the corresponding SSID(s). In addition to Beacon frames, SSIDs may be present in management frames such as Probe Requests, Probe Responses, Association Requests, and Reassociation Requests. In some embodiments, the SSID may be required to be present in one or more of the management frames (e.g., Association Request and Reassociation Request frames) for the association and/or re-association (or other action) to proceed.

SSIDs are traditionally transmitted over the air in plain text form, and consequently have been viewed as an open invitation to hackers or attackers. One existing solution is to “hide” the SSID by giving out a null SSID in the Beacon or refusing to answer a Probe Request if the SSID in the Probe Request doesn't specifically match with the SSID of the access point (AP). However, this manner of hiding the SSID may be ineffective as there are other ways to obtain the SSID when it is in plain text form, e.g., by passively monitoring the wireless medium for a legitimate client device that is trying to actively scan or associate with the AP, or by actively sending a faked Deauthentication frame to an already connected legitimate client device and then monitoring its Reassociation Request, and the like.

Additionally, there is the issue of user privacy, as the SSIDs of a STA's preferred WLANs, which may be sent in the Probe Request, Association Request, or Reassociation Request frames, together with the media access control (MAC) address of the STA, which is generally included in the transmitter address (TA) field in these frames, can be used for tracking user location, inferring a user's personal lifestyle (e.g. by the entertainment places visited) or health condition (e.g. by the medical doctor's office visited), or social relationship between users (e.g. by a shared WLAN of a business office or school), and the like. Accordingly, systems and methods for addressing the security and privacy issues are desired.

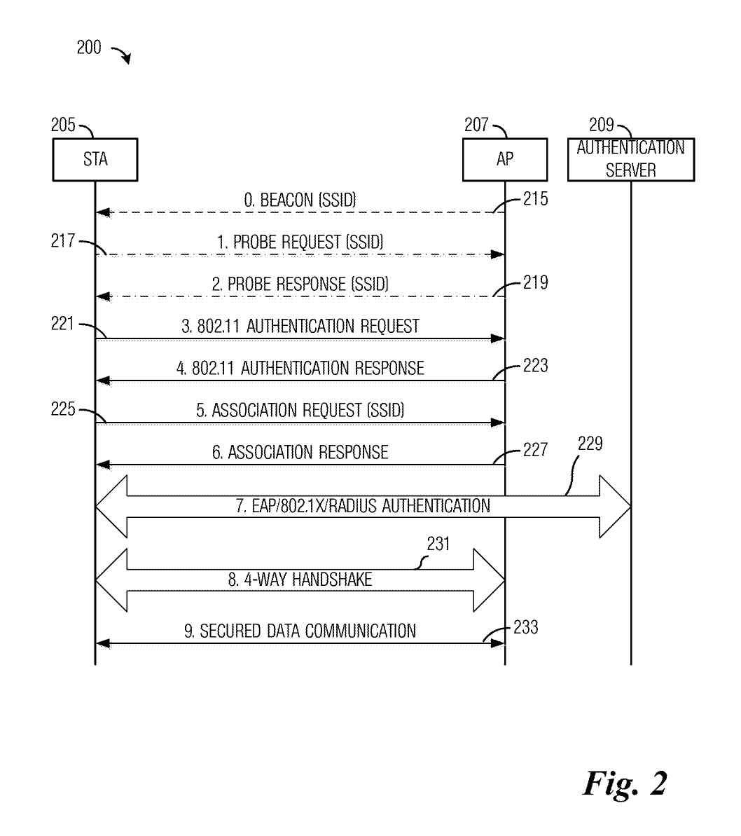

FIG. 2 illustrates a diagram 200 illustrating messages exchanged between communicating devices as a station connects with an access point. Diagram 200 highlights messages exchanged between a STA 205, an AP 207, and an authentication server 209. STA 205 may discover AP 207 via passive scanning (e.g., when STA 205 receives a beacon frame transmitted by AP 207 (shown as event 215)) or active scanning (e.g., when STA 205 sends a probe request frame (shown as event 217) and receives a corresponding probe response frame (shown as event 219)). Through passive scanning or active scanning, STA 205 may be able to obtain sufficient information about AP 207 to determine that it can associate with AP 207. As an example, STA 205 may be able to obtain a service set identifier (SSID) of AP 207.

After deciding to associate with AP 207, STA 205 may first initiate an IEEE 802.11 open system authentication procedure by sending an authentication request frame (shown as event 221) and receiving a corresponding authentication response frame (shown as event 223) from AP 207. Then, STA 205 may initiate an IEEE 802.11 association procedure by sending an association request frame (shown as event 225) and receiving a corresponding association response frame (shown as event 227) from AP 207. It is noted that the association request frame includes the SSID of AP 207. In general, the authentication and association procedures exchange robust security network (RSN) parameters between STA 205 and AP 207.

STA 205 and authentication server 209 may perform an extensible authentication protocol (EAP)/IEEE 802.1X/Radius authentication procedure (shown as event 229) to supplement the IEEE 802.11 open system authentication with mutual authentication. Additionally, STA 205 and AP 207 may perform a four-way handshake (shown as event 231) to ensure that STA 205 can trust AP 207 and allow the two to share their keys along with the indication of the pair-wise master key (PMK). STA 205 and AP 207 may then be able to conduct secured communications (shown as event 233).

According to an example embodiment, the above mentioned security and/or privacy concerns may be addressed by using an identifier for an AP that is generated from the SSID of the AP so that the SSID is not transmitted over the wireless fidelity (Wi-Fi) air interface in plain text form. The SSID (in plain text form) may be pre-installed on legitimate client devices by secured means, e.g., manual user input via a setup menu on the client device, using the Wi-Fi Protected Setup (WPS) procedure, using an out-of-band channel such as a cellular connection or a near field communications (NFC) link as a part of an authorization process, and the like. The identifier may be used by legitimate client devices to recognize or to indicate its preferred WLAN, while a hacker or unauthorized client device is not able to derive the SSID from the identifier.

As discussed previously, conventional solutions that address security and/or privacy issues generally involve the establishment of a shared encryption key between the client device (e.g., STA) and the AP before transmitting the encrypted SSID (i.e., the identifier) over the air. Such solutions may require significant change to existing standardized procedures and incur additional delay due to the steps involved in the establishment of the shared encryption key prior to the attachment of the client device to the AP.

The systems and methods presented herein provide increased SSID security and/or privacy, as well as end user privacy (such as location, interests, and the like), thereby making it more costly for a hacker to impersonate a legitimate AP or STA, while maintaining backward compatibility so that legacy STAs and/or APs do not operate improperly when the identifier (e.g., the encrypted SSID) is used in place of the unsecured SSID.

As discussed above, hiding SSIDs may be ineffective (from a security standpoint) because there are other ways to obtain the SSID. As an example, hackers may passively monitor the wireless medium for a legitimate client device trying to actively scan or associate with an AP. With a hidden SSID in the beacon, the legitimate client devices are forced to perform active scanning, e.g., client devices send out probe requests containing the SSID of the AP they wish to join and listen for a probe response containing the same SSID. In both occasions, the SSID is in plain text form. Additionally, hackers may fake a de-authenticate message to an already connected legitimate client device and then monitor its re-association requests (active), which contain the SSID of the AP in plain text form. The probe request, which is transmitted far more frequently than the association request and re-association request, can be a good source for a hacker to obtain the SSIDs. On the other hand, a hacker can use the de-authentication trick to force a re-association request, with a more predictable delay.

According to an example embodiment, an identifier is generated from the SSID of an AP and used in place of the SSID so that the SSID is not transmitted over the Wi-Fi air interface (i.e., the wireless medium) in plain text form. In some example embodiments, an SSID (in the form of the identifier) may be communicated using a cryptographically hashed SSID instead of the plain text SSID. As an illustrative example, the cryptographically hashed SSID may be generated using a hash function, such as a SHA-256 function, and the like. The output of the hash function may be further truncated to a fixed and shorter length.

In some example embodiments, the SSID may be modified by a string or value prior to being hashed. As an illustrative example, a timestamp that is provided in a beacon frame or a probe response frame (in a TimeStamp field) may be used to modify the SSID before hashing so that hackers will not receive the same hashed SSID twice, as it takes more than 580000 years before the 64-bit Timestamp repeats itself. The use of the timestamp to modify the SSID will make it more costly for a hacker to try to impersonate a legitimate AP. The SSID may also be modified by the type of frame that is used to carry the hashed SSID. Aspects of this disclosure are related to descriptions in co-assigned U.S. patent application Ser. No. 14/105,895, Filed Dec. 13, 2013, which is incorporated by reference herein as if reproduced in its entirety. Further, the SSID may be modified by a random number (such as a nonce) or sequence number generated by the STA or AP, or by an identifier (e.g. MAC address) of the STA or AP. As an STA never includes the Timestamp in any frame that the STA sends out, the STA may use a nonce in generating the hashed SSID to avoid sending out a static hashed SSID and the STA may provide the nonce value to the AP. Then, if the AP stores the nonce values that have been recently used by legitimate STAs, the AP may refuse to respond to a request frame that uses a same nonce value that has been recently used. In this way, the use of a nonce to modify the SSID can help to make it more costly for a hacker to try to impersonate the legitimate STA.

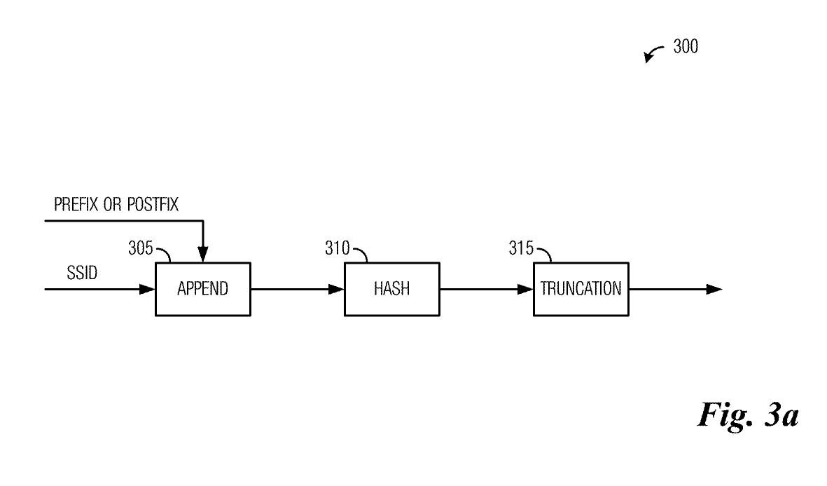

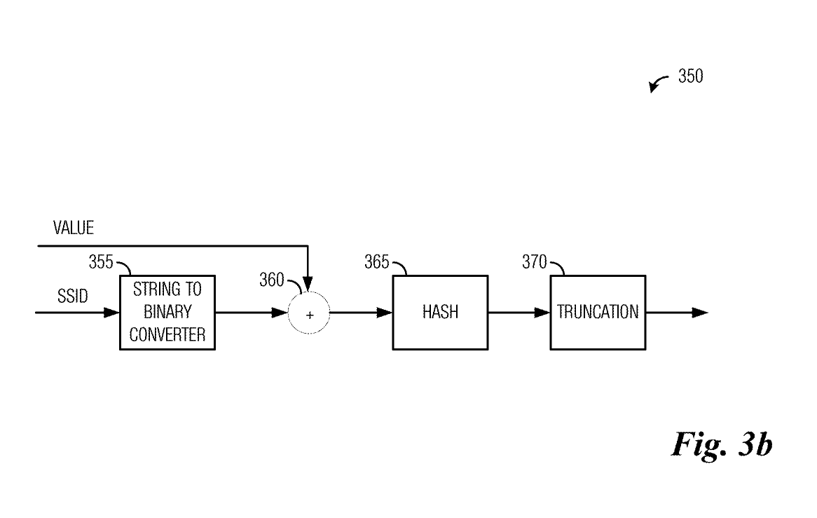

FIG. 3a illustrates a first example hashed SSID generator 300. Hashed SSID generator 300 may include an append unit 305 that appends a string expression of a frame type, timestamp, nonce, MAC address, or a combination thereof, and appends it as a prefix or a postfix to an SSID (which may be in plain text form). A hashing unit 310 may perform a hashing on a given input (as provided by append unit 305) based on a cryptographic hash function, such as the SHA-256 hash function, and the like. A truncation unit 315 may truncate a hash output (as provided by hashing unit 310) to a specified length, providing a shorter and fixed length for lower overhead and simpler design of an information element (IE) that carries the hashed SSID.

FIG. 3b illustrates a second example hashed SSID generator 350. Hashed SSID generator 350 may include a string to binary converter 355 that converts a plain text string, such as the SSID in plain text form, into a numerical value (which may be represented in binary form). It should be noted that binary numbers and a String to Binary Converter are only used here as an example and using other numeral systems with different bases are also possible. An adder 360 may combine the numerical value produced by string to binary converter 355 and a value that is a numerical value pre-defined for a frame type, a timestamp, a nonce, a MAC address, a combination thereof, and the like, to produce a sum of the two numerical values. A hashing unit 365 may perform a hashing on a given input (as provided by adder 360) based on a cryptographic hash function, such as the SHA-256 hash function, and the like. A truncation unit 370 may truncate a hash output (as provided by hashing unit 365) to a specified length, providing a shorter and fixed length for lower overhead and simpler design of an information element (IE) that carries the hashed SSID.

It may be advantageous to reuse the legacy SSID IE to maintain compatibility with legacy APs and/or STAs while providing the enhanced security and privacy afforded through the use of hashed SSIDs. The hashed SSID, as produced by example hashed SSID generators 300 and 350, is generally an unintelligible sequence of bits. So, it is highly unlikely that the hashed SSID will match with any SSID that is in the plain text form.

According to an example embodiment, the SSID field of the SSID IE contains the hashed SSID and the Length field of the SSID IE indicates the specified length of the hashed SSID (after the truncation). A hashed SSID capable AP or STA, when receiving an SSID IE with the Length field set to a value that is equal to the specified length of the hashed SSID, blindly checks to determine if any hashed SSIDs of its SSIDs matches with the content of the SSID field of the received SSID IE. Additionally, if any plain-text SSID of the AP or stored at the STA happens to have a length equal to the specified length of the hashed SSID (e.g., indicated in the Length field of the received SSID IE) and if the configuration of the AP or the STA allows it to check unprotected SSID (i.e., a plain-text SSID), the hashed SSID capable AP or STA may also check to determine if that plain-text SSID matches with the content of the SSID field of the received SSID IE. If there is a match, then it is determined that the associated SSIDs match. While if the Length field of the received SSID IE is set to a value that is not equal to the specified length of the hashed SSID, a hashed SSID capable AP or STA treats the received SSID IE as a conventional SSID IE, which carries an SSID in the plain text form. Then if the configuration of the AP or the STA allows it to check unprotected SSID, the hashed SSID capable AP or STA checks if any of its plain-text SSIDs matches with the content of the SSID field of the received SSID IE. A legacy AP or legacy STA uses an SSID in the plain-text form to perform matching with the content of the SSID field of the received SSID IE, even though the SSID IE may be reused by a hashed SSID capable AP or STA to carry a hashed SSID. However, as mentioned before, the hashed SSID, as produced by example hashed SSID generators 300 and 350, is generally an unintelligible sequence of bits. So, it is highly unlikely that the hashed SSID will match with any SSID that is in the plain text form. Therefore, in this example embodiment of reusing the legacy SSID IE, the specified length value contained in the Length field of the SSID IE serves as an indicator of possible presence of hashed SSID in the SSID field of the SSID IE. However, a recipient of the SSID IE doesn't know for sure that a hashed SSID is carried since some plain-text SSID may happen to have the same length as the hashed SSID.

According to another example embodiment, a pre-defined value, a pre-defined string, a pre-defined sequence, and the like, may be combined (such as appended, inserted, interleaved, and the like) with the hashed SSID, and the combined string or sequence is contained in the SSID field of the SSID IE. The length of the combined string or sequence is also a specified value, since the lengths of both parts are pre-defined. Therefore, the pre-defined value, string, or sequence included in a pre-defined portion of the SSID field, together with the specified length value (of the combined string) contained in the Length field, serves as an indicator to the hashed SSID capable APs and STAs that a remainder of the SSID field of the SSID IE contains a hashed SSID. A hashed SSID capable AP or STA receiving a SSID IE with a Length field set to the specified length value knows that the remainder of the SSID field holds a hashed SSID, if it is able to find in a pre-defined portion of the SSID field a pre-defined value, a pre-defined string, a pre-defined sequence, and the like.

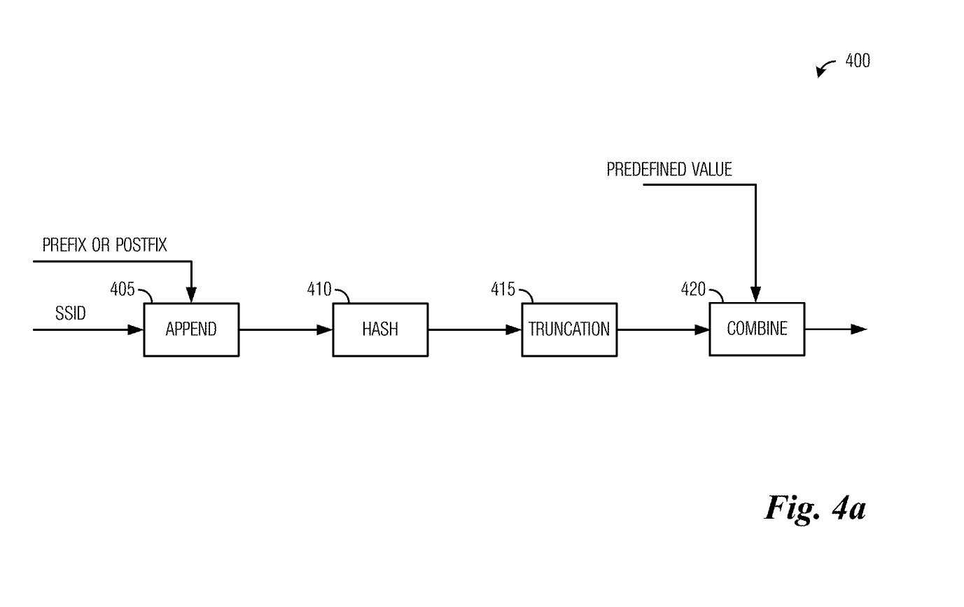

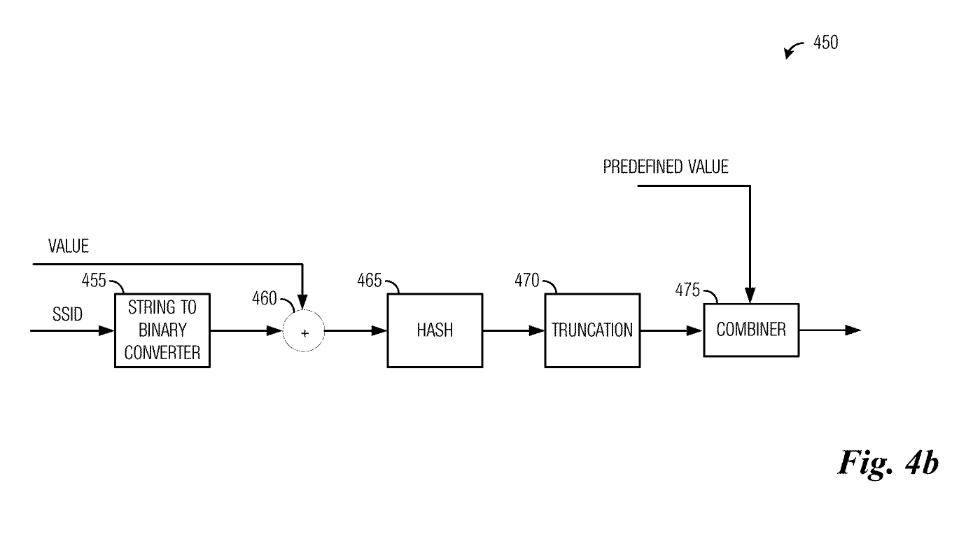

FIG. 4a illustrates a first example hashed SSID generator 400 that generates a legacy SSID IE compliant hashed SSID. Hashed SSID generator 400 may include an append unit 405 that appends a string expression of a frame type, timestamp, MAC address, or a combination thereof, and appends it as a prefix or a postfix to a SSID (which may be in plain text form). A hashing unit 410 may perform a hashing on a given input (as provided by append unit 405) based on a cryptographic hash function, such as the SHA-256 hash function, and the like. A truncation unit 415 may truncate a hash output (as provided by hashing unit 410) to a specified length. A combine unit 420 may combine (such as append, insert, interleave, and the like) the truncated hashed SSID (as provided by truncation unit 415) with a pre-defined value (or a pre-defined string, a pre-defined sequence, and the like).

FIG. 4b illustrates a second example hashed SSID generator 450 that generates a legacy SSID IE compliant hashed SSID. Hashed SSID generator 450 may include a string to binary converter 455 that converts a plain text string, such as the SSID in plain text form, into a numerical value (which may be represented in binary form). It should be noted that binary numbers and a String to Binary Converter are only used here as an example and using other numeral systems with different bases are also possible. An adder 460 may combine the numerical value produced by string to binary converter 455 and a value that is a numerical value pre-defined for a frame type, a timestamp, a nonce, a MAC address, a combination thereof, and the like, to produce a sum of the two numerical values. A hashing unit 465 may perform a hashing on a given input (as provided by adder 460) based on a cryptographic hash function, such as the SHA-256 hash function, and the like. A truncation unit 470 may truncate a hash output (as provided by hashing unit 465) to a specified length. A combine unit 475 may combine the truncated hashed SSID (as provided by truncation unit 470) with a pre-defined value (or a pre-defined string, a pre-defined sequence, and the like).

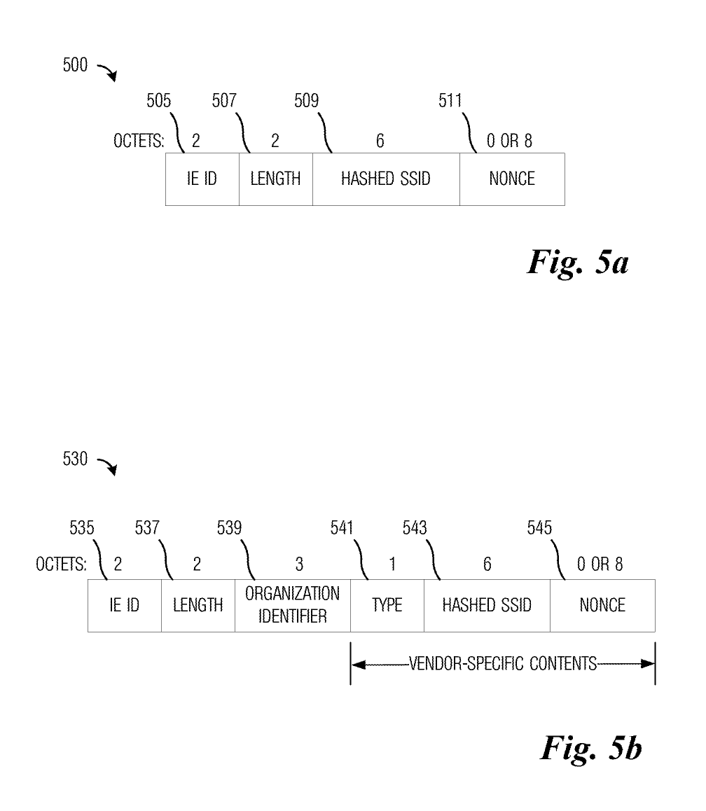

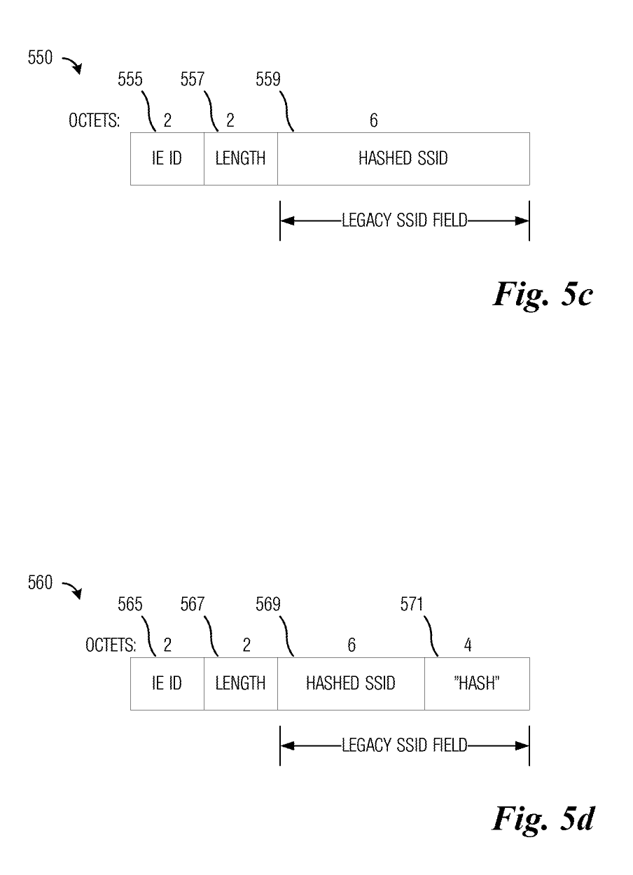

FIG. 5a illustrates a first example hashed SSID IE 500. Hashed SSID IE 500 includes an IE ID field 505 carrying a new IE identifier defined for Hashed SSID IE 500, a Length field 507 indicating the number of total octets after Length field 507 in Hashed SSID IE 500, and a Hashed SSID field 509 carrying the truncated hashed SSID (e.g., the first six octets the hashed SSID). A Nonce field 511 may be optionally present in Hashed SSID IE 500 to indicate a random number, which is generated and used for generating the hashed SSID by an AP or STA transmitting Hashed SSID IE 500. The presence or absence of the Nonce field in Hashed SSID IE 500 may be inferred from the value of Length field 507.

FIG. 5b illustrates a second example hashed SSID IE 530. Hashed SSID IE 530 may also be used in Wi-Fi Alliance (WFA) certification specification by using IEEE 802.11 defined vendor-specific IE format. Aspects of this disclosure may relate to IEEE Standard 802.11-2012, which is incorporated herein by reference as if reproduced in its entirety. As shown in FIG. 5b, Hashed SSID IE 530 includes an IE ID field 535 set to the value of “221” for 802.11 defined vendor-specific IE format, a Length field 537 specifying the number of total octets after Length field 537 in hashed SSID IE 530, an Organization Identifier (OI) field 539 set to the value of “50 6F 9A” for WFA (Wi-Fi Alliance), a type field 541 carrying a new identifier allocated by WFA for Hashed SSID IE 530, a Hashed SSID field 543, and optionally a Nonce field 545. The presence or absence of Nonce field 545 in Hashed SSID IE 530 may be inferred from the value of Length field 537. It should be noted that WFA is used here merely as an example. Other organizations or manufacturers may use the IEEE 802.11 defined vendor-specific IE format with similar IE contents as described here, except OI field 539 should be set to represent the appropriate organization, to implement the same concept.

FIG. 5c illustrates a first example legacy SSID IE 550 with legacy SSID field support for hashed SSIDs. Legacy SSID IE 550 includes an IE ID field 555 carrying an IE identifier assigned for legacy SSID IEs, a Length field 557 indicating the number of total octets after Length field 557 in legacy SSID IE 550, a Hashed SSID field 559 carrying the truncated hashed SSID (e.g., the first six octets of the hashed SSID). Furthermore, Hashed SSID field 559 being 6 in length is used as an example and, depending on the truncation function used (such as truncation units 315 and 370), that other lengths are possible as long as the length meets legacy SSID IE specifications. It is noted that Hashed SSID field 559 has the same format and/or structure as the legacy SSID field. Therefore, a legacy AP and/or STA that receives legacy SSID IE 550 may interpret the legacy SSID field as containing an SSID in plain text form.

FIG. 5d illustrates a second example legacy SSID IE 560 with legacy SSID field support for hashed SSIDs. Legacy SSID IE 560 includes an IE ID field 565 carrying an IE identifier assigned for legacy SSID IEs, a Length field 567 indicating the number of total octets after Length field 567 in legacy SSID IE 560, a Hashed SSID field 569 carrying the truncated hashed SSID (e.g., the first six octets of the hashed SSID), and a Pre-defined Value field 571 carrying a pre-defined value, e.g., a text string “HASH”. It is noted that “HASH” is used here merely as an example and that other text strings, pre-defined values, pre-defined sequences, and the like, may be used. Since most SSIDs are strings of human-readable alphabets, numerical numbers, and a few common symbols such as “-”, “.”, “,”, “#”, “̂”, “*”, “@”, and the like, special efforts may be made to avoid using any of these characters in the pre-defined value, string, or sequence to reduce the chances of having a false match. It is also noted that the pre-defined value being located at the end of the truncated hashed SSID is used as an example and that other positions of the pre-defined value are possible. Furthermore, Hashed SSID field 569 and Pre-defined Value field 571 being 6 and 4 octets in length, respectively, are used as examples and that other lengths are possible as long as their combined length meets legacy SSID IE specifications. Hashed SSID field 569 and Pre-defined Value field 571 make up a legacy SSID field, therefore, a legacy AP and/or STA that has received legacy SSID IE 560 may interpret the legacy SSID field (comprising Hashed SSID field 569 and Pre-defined Value field 571) as containing an SSID in plain text form.

In some embodiments, the presence of a Hashed SSID IE in the Beacon or Probe Response frame indicates that the AP is capable of using Hashed SSID. In the same or other embodiments, the presence of a Hashed SSID IE in the Probe Request, Association Request, or Reassociation Request frame indicates that the STA is capable of using Hashed SSID.

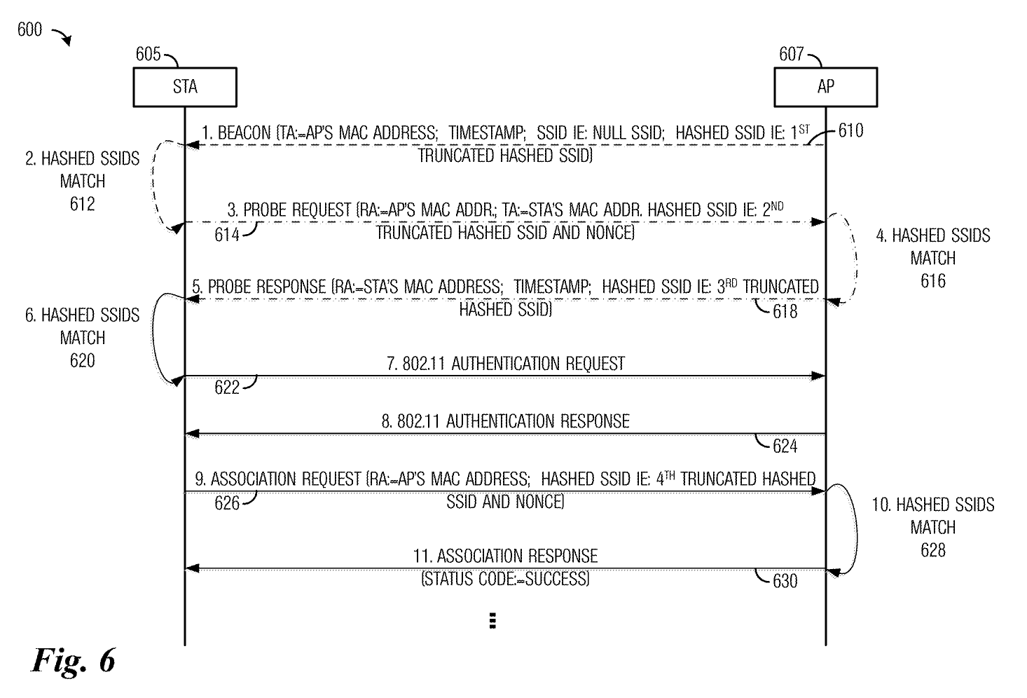

FIG. 6 illustrates a message exchange diagram 600 of example messages exchanged between a STA and an AP as the STA connects with the AP. Message exchange diagram 600 illustrates example messages exchanged between a STA 605 and an AP 607, as well as operations performed by STA 605 and/or AP 607. Message exchange diagram 600 may begin with AP 607, which is hashed SSID compliant, broadcasts a Beacon frame (shown as event 610). The Beacon frame includes: a TA field set to the MAC address of AP 607, a TimeStamp field, an SSID IE set to a null SSID, a Hashed SSID IE that includes a first truncated hashed SSID generated from the SSID of AP 607, which would have been broadcasted explicitly otherwise.

The details of generating different hashed identifiers from the same input are described earlier, in FIGS. 3a, 3b, 4a, and 4b, and in co-assigned U.S. patent application Ser. No. 14/105,895. The content of the TimeStamp field, which changes constantly and repeats only after more than 580,000 years, when used in generating the Hashed SSID, helps AP 607 to avoid sending a static Hashed SSID so as to make it more costly for an attacker trying to impersonate as AP 607. A legacy STA sees the Beacon frame as a Beacon frame with hidden SSID enabled. Typically, the legacy STA may ignore the Hashed SSID IE as it doesn't understand the IE ID. The legacy STA may check if the MAC address of AP 607 belongs to one of the APs in its preferred WLAN List. If not, the legacy STA may ignore AP 607.

STA 605, recognizing the Hashed SSID IE, may perform a check to determine if the first truncated hashed SSID included in the Hashed SSID IE matches with one or more truncated hashed SSID generated by STA 605 utilizing SSID(s) of APs in the preferred WLAN list of STA 605 (shown as event 612). STA 605 may use a technique for generating truncated hashed SSIDs, such as those discussed previously in FIGS. 3a, 3b, 4a, and 4b. As an illustrative example, STA 605 may use the value contained in the TimeStamp field of the Beacon frame to generate the truncated hashed SSIDs. STA 605 may compare the truncated hashed SSIDs and if there is a match, STA 605 may consider that AP 607 is a member of its preferred WLAN list. It is noted that both STA 605 and AP 607 use the same hashing function, such as SHA-256. Events 610 and 612 may be considered to be part of a passive scanning procedure wherein STA 605 can obtain information about AP 607 so that STA 605 can decide to connect with or to not connect with AP 607.

Alternatively, the Beacon frame includes: a TA field set to the MAC address of AP 607, a TimeStamp field, a legacy SSID IE with a SSID field that contains the first truncated hashed SSID and with a Length field set to a pre-defined value that indicates that the SSID field actually contains a hashed SSID, as described in FIG. 5c, for example. The pre-defined value is the length of the first truncated hashed SSID. Since STA 605 recognizes that the SSID field contains a hashed SSID, STA 605 may perform event 612 as described previously.

Yet alternatively, the Beacon frame includes: a TA field set to the MAC address of AP 607, a TimeStamp field, and a legacy SSID IE with a Length field set to a first pre-defined value and with a SSID field that contains the first truncated hashed SSID and a second pre-defined value that (together with the first pre-defined value) indicates that the remaining portion of the SSID field actually contains a hashed SSID, as described in FIG. 5d, for example. The first pre-defined value is a sum of the length of the hashed SSID and the length of the second pre-defined value. Since STA 605 recognizes that the SSID field contains a hashed SSID, STA 605 may perform event 612 as described previously.

Active scanning is another scanning procedure wherein STA 605 can obtain information about AP 607 so that STA 605 can decide to connect with or to not connect with AP 607. Active scanning may include STA 605 transmitting a Probe Request frame to AP 605 (shown as event 614). The Probe Request frame includes: a Receiver Address (RA) field set to the MAC address of AP 607, a TA field set to the MAC address of STA 605, a Hashed SSID IE that includes a second truncated hashed SSID generated from a SSID that STA 605 anticipates as the SSID of AP 607, and optionally, a Nonce used by STA 605 in the generating of the second truncated hashed SSID. Alternatively, the Probe Request frame includes: a RA field set to the MAC address of AP 607, a TA field set to the MAC address of STA 605, and a legacy SSID IE with a SSID field that contains the second truncated hashed SSID and with a Length field set to a pre-defined value that indicates that the SSID field actually contains a hashed SSID, as described in FIG. 5c, for example. Yet alternatively, the Probe Request frame includes: a RA field set to the MAC address of AP 607, a TA field set to the MAC address of STA 605, and a legacy SSID IE with a Length field set to a first pre-defined value and with a SSID field that contains the second truncated hashed SSID and a second pre-defined value that (together with the first pre-defined value) indicates that the remaining portion of the SSID field actually contains a hashed SSID, as described in FIG. 5d, for example.

Active scanning may also include AP 607 performing a check to determine if the second truncated hashed SSID included in Hashed SSID IE in the Probe Request frame matches with a truncated hashed SSID generated by AP 607 (shown as event 616). AP 607 may use a technique for generating truncated hashed SSIDs, such as those discussed previously in FIGS. 3a, 3b, 4a, and 4b. As an illustrative example, AP 607 may use the Nonce (or the transmitter address (TA), i.e., the MAC address of the STA, if the legacy SSID IE is used) in the Probe Request frame and its own SSID to generate the truncated hashed SSID to compare with the second truncated hashed SSID. Alternatively, AP 607 may perform a check to determine if the second truncated hashed SSID included in legacy SSID IE in the Probe Request frame matches with a truncated hashed SSID generated by AP 607.

It is noted that related truncated hashed SSIDs, such as the first truncated hashed SSID included in the Beacon frame (event 610) and the truncated hashed SSID(s) generated by STA 605 in event 612, as well as the second truncated hashed SSID included in the Probe Request frame (event 614) and the truncated hashed SSID generated by AP 607 in event 616, and the like, are generated using the same hash function. The use of the same hash function ensures that matching SSIDs result in matching truncated hashed SSIDs. If different hash functions are used, the probability of matching truncated hashed SSIDs even with matching SSIDs is practically zero. However, unrelated truncated hashed SSIDs may be generated using different hash functions.

If there is a match, AP 607 may send a Probe Response frame to STA 605 (shown as event 618). The Probe Response frame includes: a RA field set to the MAC address of STA 605, a TimeStamp field, and a Hashed SSID IE that includes a third truncated hashed SSID generated from the SSID of AP 607. Alternatively, the Probe Response frame includes: a RA field set to the MAC address of STA 605, a TimeStamp field, and a legacy SSID IE with an SSID field that contains the third truncated hashed SSID and with a Length field set to a pre-defined value that indicates that the SSID field actually contains a hashed SSID. Yet alternatively, the Probe Response frame includes: a RA field set to the MAC address of STA 605, a TimeStamp field, and a legacy SSID IE with a Length field set to a first pre-defined value and with an SSID field that contains the third truncated hashed SSID and a second pre-defined value that (together with the first pre-defined value) indicates that the remaining portion of the SSID field actually contains a hashed SSID.

Active scanning may also include STA 605 performing a check to determine if the third truncated hashed SSID included in the Hashed SSID IE in the Probe Response frame matches with a truncated hashed SSID generated by STA 605 (shown as event 620). STA 605 may use a technique for generating truncated hashed SSIDs, such as those discussed previously in FIGS. 3a, 3b, 4a, and 4b. As an illustrative example, STA 605 may use a value in the TimeStamp field in the Probe Response frame to generate the truncated hashed SSID. STA 605 may compare the truncated hashed SSID with the third truncated hashed SSID and if there is a match, STA 605 may consider that AP 607 is a member of its preferred WLAN list. Alternatively, STA 605 may perform a check to determine if the third truncated hashed SSID included in the legacy SSID IE in the Probe Response frame matches with a truncated hashed SSID generated by STA 605. Co-assigned U.S. patent application Ser. No. 14/105,895 describes why and how using difference truncated hash of the same ID in subsequent frames (with different frame types, Timestamp values, nonce values, etc.) and checking iteratively if the match persists can help to reduce the residual false match probability. At any subsequent step, if the corresponding Hashed SSIDs no longer matches, the discovery or association procedure may be stopped.

Generally, STA 605 may use active scanning or passive scanning and usually not both active scanning and passive scanning. However, a situation may arise where STA 605 does not have sufficient information from the Beacon frame and STA 605 may utilize active scanning to obtain additional information from AP 607 before making its decision to whether or not connect with AP 607, for example. In such a situation, STA 605 may perform both passive scanning and active scanning.

STA 605, after determining to connect with AP 607, may transmit an IEEE 802.11 Authentication Request frame (shown as event 622). STA 605 may determine to connect with AP 607 after performing passive scanning (events 610 and 612) or active scanning (events 614, 618, and 620). AP 607 may transmit an IEEE 802.11 Authentication Response frame (shown as event 624). Events 622 and 624 are part of the IEEE 802.11 Open System Authentication procedure.

STA 605 may send an Association Request frame (shown as event 626). The Association Request frame includes: a RA field set to the MAC address of AP 607, a Hashed SSID IE that includes a fourth truncated hashed SSID generated from a SSID that STA 605 anticipates as the SSID of AP 607, and optionally, a Nonce used by STA 605 in the generating of the fourth truncated hashed SSID. Alternatively, the Association Request frame includes: a RA field set to the MAC address of AP 607, and a legacy SSID IE with a SSID field that contains the fourth truncated hashed SSID and with a Length field set to a pre-defined value that indicates that the SSID field actually contains a hashed SSID. Yet alternatively, the Association Request frame includes: a RA field set to the MAC address of AP 607, and a legacy SSID IE with a Length field set to a first pre-defined value and with a SSID field that contains the fourth truncated hashed SSID and a second pre-defined value that indicates (together with the first pre-defined value) that the remaining portion of the SSID field actually contains a hashed SSID. AP 607 may perform a check to determine the fourth truncated hashed SSID included in the Hashed SSID IE (or alternatively, the legacy SSID IE configured as shown in FIG. 5c or 5d) in the Association Request frame matches with a truncated hashed SSID generated by AP 607 (shown as event 628). AP 607 may use a technique for generating truncated hashed SSIDs, such as those discussed previously in FIGS. 3a, 3b, 4a, and 4b. As an illustrative example, AP 607 may use the Nonce (or the TA, i.e., the MAC address of the STA, if the legacy SSID IE is used) in the Association Request frame and its own SSID to generate the truncated hashed SSID to compare with the fourth truncated hashed SSID. If there is a match, AP 607 may send an Association Response frame (shown as event 630). The Association Response frame may include a status code set to SUCCESS. The example messages exchanged between STA 605 and AP 607 may also include messages involved in EAP/802.1X/Radius authentication, a 4-way handshake, and secured data communications.

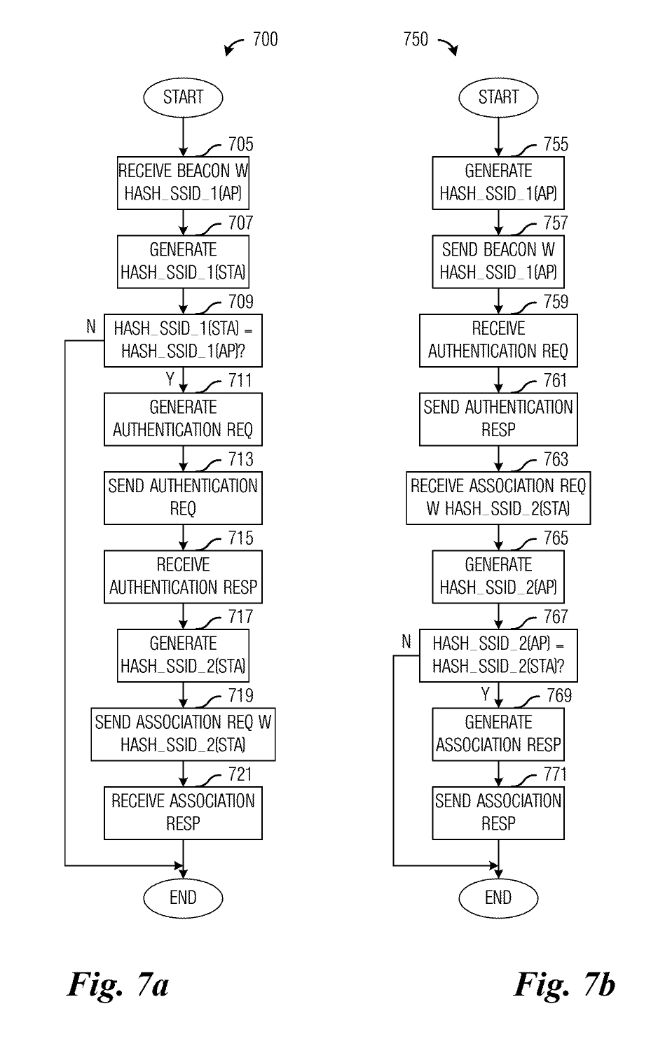

FIG. 7a illustrates a flow diagram of example operations 700 occurring in a STA as the STA connects to an AP using a passive scanning procedure. Operations 700 may be indicative of operations occurring in a STA, such as STAs 110-118, as the STA connects to an AP, such as AP 105, using a passive scanning procedure.

Operations 700 may begin with the STA receiving a Beacon frame broadcast by the AP that includes a first truncated hashed SSID, denoted HASH_SSID_{—}1(AP) (block 705). HASH_SSID_{—}1(AP) may have been generated using an SSID associated with the AP. HASH_SSID_{—}1(AP) may have been generated using the SSID associated with the AP modified with a value, e.g., a timestamp, a frame type, a frame sequence number, and the like, to help prevent a static hashed SSID from occurring. The Beacon frame may include the value used to modify the SSID so that the STA will be able to recreate the truncated hashed SSID. The STA may generate its own first truncated hashed SSID, denoted HASH_SSID_{—}1(STA) (block 707). Since the Beacon frame did not include the SSID of the AP, the STA may utilize SSIDs of APs that are in its preferred WLAN list, an SSID associated with a MAC address of the AP, and the like.

The STA may perform a check to determine if HASH_SSID_{—}1(STA) is equal to HASH_SSID_{—}1(AP) (block 709). If HASH_SSID_{—}1(STA) is not equal to HASH_SSID_{—}1(AP), then operations 700 may end since the STA does not know the SSID of the AP. If HASH_SSID_{—}1(STA) is equal to HASH_SSID_{—}1(AP), the STA may generate an Authentication Request frame (block 711) and send the Authentication Request frame to the AP (block 713). The STA may receive an Authentication Response frame (block 715).

The STA may generate a second truncated hashed SSID, denoted HASH_SSID_{—}2(STA) (block 717). HASH_SSID_{—}2(STA) may be generated from the SSID used in generating HASH_SSID_{—}1(STA) which resulted in the match with HASH_SSID_{—}1(AP), in other words, the SSID of the AP. The STA may use a value to modify the SSID, e.g., a Nonce, to help prevent a static hashed SSID from occurring. The STA may send an Association Request frame including the HASH_SSID_{—}2(STA) to the AP (block 719). The STA may include the Nonce value used to modify the SSID in the Association Request frame so that the AP will be able to recreate the truncated hashed SSID. If the AP verified the SSID used by the STA with its own SSID, the STA may receive an Association Response frame from the AP with a Status Code set to SUCCESS (block 721).

The truncated hashed SSIDs may be sent from the STA to the AP or from the AP to the STA in a Hashed SSID IE configured as described previously. Alternatively, the truncated hashed SSIDs may be sent from the STA to the AP or from the AP to the STA in a legacy SSID IE configured as described previously.

FIG. 7b illustrates a flow diagram of example operations 750 occurring in an AP as a STA connects to the AP using a passive scanning procedure. Operations 700 may be indicative of operations occurring in an AP, such as such as AP 105, as a STA, such as STAs 110-118, connects to the AP, using a passive scanning procedure.

Operations 750 may begin with the AP generating a first truncated hashed SSID, denoted HASH_SSID_{—}1(AP) (block 755). HASH_SSID_{—}1(AP) may be generated from the SSID of the AP. The SSID of the AP may be modified with a value, such as a timestamp, a frame type, a frame sequence number, and the like, prior to hashing. The AP may transmit a Beacon frame including the HASH_SSID_{—}1(AP) (block 757). The Beacon frame may include the value used to modify the SSID so that the STA will be able to recreate the truncated hashed SSID. The AP may receive an Authentication Request frame from the STA (block 759) and send an Authentication Response frame to the STA (block 761).

The AP may receive an Association Request frame from the STA with a second truncated hashed SSID, denoted HASH_SSID_{—}2(STA) (block 763). The AP may generate a second truncated hashed SSID, denoted HASH_SSID_{—}2(AP) (block 765). HASH_SSID_{—}2(AP) may be generated from the SSID of the AP. The AP may use a value to modify the SSID, e.g., a Nonce provided by the STA in the Associated Request frame. The AP may perform a check to determine if HASH_SSID_{—}2(AP) is equal to HASH_SSID_{—}2(STA) (block 767). If HASH_SSID_{—}2(AP) is not equal to HASH_SSID_{—}2(STA), then operations 750 may end since the SSID of the AP does not match with the SSID of a WLAN that the STA is attempting to connect with. If HASH_SSID_{—}2(AP) is equal to HASH_SSID_{—}2(STA), the AP may generate an Association Response frame (block 769). The Association Response frame may include a Status Code set to SUCCESS. The AP may send the Association Response frame to the STA (block 771).

The truncated hashed SSIDs may be sent from the STA to the AP or from the AP to the STA in a Hashed SSID IE configured as described previously. Alternatively, the truncated hashed SSIDs may be sent from the STA to the AP or from the AP to the STA in a legacy SSID IE configured as described previously.

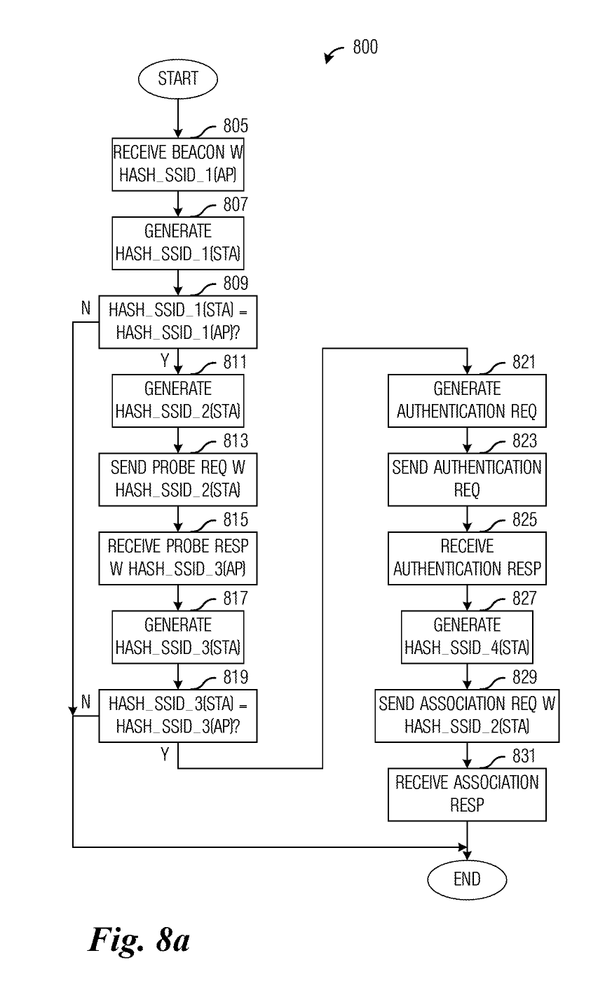

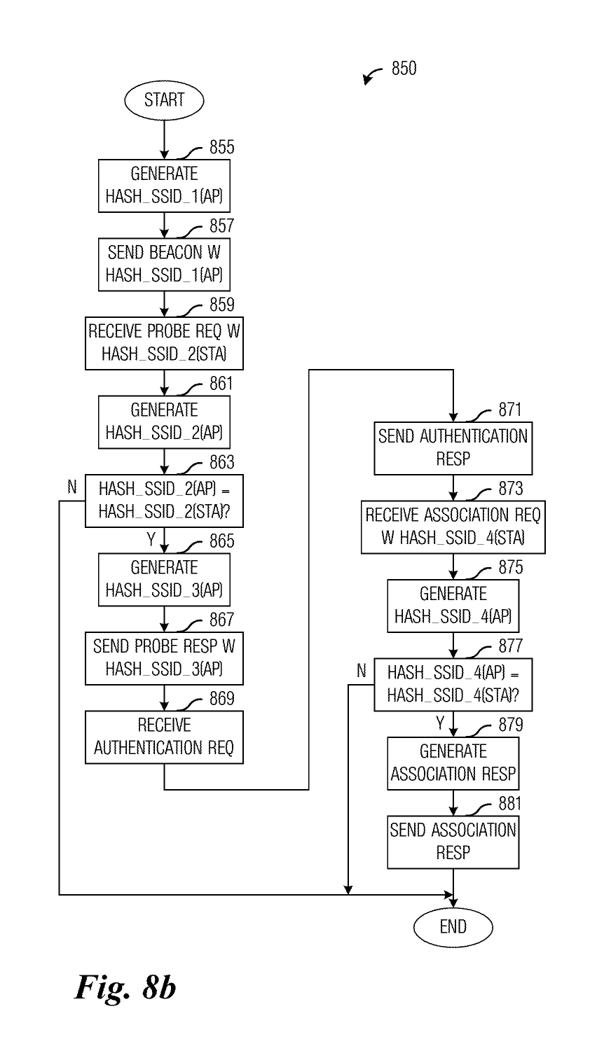

FIG. 8a illustrates a flow diagram of example operations 800 occurring in a STA as the STA connects to an AP using a combination of passive and active scanning procedures. Operations 800 may be indicative of operations occurring in a STA, such as STAs 110-118, as the STA connects to an AP, such as such as AP 105, using a combination of passive and active scanning procedures.

Operations 800 may begin with the STA receiving a Beacon frame broadcast by the AP that includes a first truncated hashed SSID, denoted HASH_SSID_{—}1(AP) (block 805). HASH_SSID_{—}1(AP) may have been generated using an SSID associated with the AP. HASH_SSID_{—}1(AP) may have been generated using the SSID associated with the AP modified with a value, e.g., a timestamp, a frame type, a frame sequence number, and the like, to help prevent a static hashed SSID from occurring. The Beacon frame may include the value used to modify the SSID so that the STA will be able to recreate the truncated hashed SSID. The STA may generate its own first truncated hashed SSID, denoted HASH_SSID_{—}1(STA) (block 807). Since the Beacon frame did not include the SSID of the AP, the STA may utilize SSIDs of APs that are in its preferred WLAN list, an SSID associated with a MAC address of the AP, and the like.

The STA may perform a check to determine if HASH_SSID_{—}1(STA) is equal to HASH_SSID_{—}1(AP) (block 809). If HASH_SSID_{—}1(STA) is not equal to HASH_SSID_{—}1(AP), then operations 800 may end since the STA does not know the SSID of the AP. If HASH_SSID_{—}1(STA) is equal to HASH_SSID_{—}1(AP), the STA may generate a second truncated hashed SSID, denoted HASH_SSID_{—}2(STA) (block 811). HASH_SSID_{—}2(STA) may be generated using the SSID used to generate the HASH_SSID_{—}1(STA). The STA may modify the SSID with a value, e.g., a Nonce, prior to hashing. The STA may transmit a Probe Request frame including HASH_SSID_{—}2(STA) to the AP (block 813). The STA may include the value used to modify the SSID in the Probe Request frame so that the AP will be able to recreate the truncated hashed SSID.

The STA may receive a Probe Response frame from the AP that includes a third truncated hashed SSID, denoted HASH_SSID_{—}3(AP) (block 815). The STA may generate its own third truncated hashed SSID, denoted HASH_SSID_{—}3(STA) (block 817). The HASH_SSID_{—}3(STA) may be generated using the SSID used to generate HASH_SSID_{—}1(STA) and HASH_SSID_{—}2(STA). Prior to hashing, the STA may modify the SSID with a value in the Probe Response frame, e.g., a timestamp, a frame type, a frame sequence number, and the like, which is also used by the AP to generate HASH_SSID_{—}3(AP).

The STA may perform a check to determine if HASH_SSID_{—}3(STA) is equal to HASH_SSID_{—}3(AP) (block 819). If HASH_SSID_{—}3(STA) is not equal to HASH_SSID_{—}3(AP), then operations 800 may end since the SSIDs do not match. If HASH_SSID_{—}3(STA) is equal to HASH_SSID_{—}3(AP), the STA may generate an Authentication Request frame (block 821) and send the Authentication Request frame to the AP (block 823). The STA may receive an Authentication Response frame (block 825).

The STA may generate a fourth truncated hashed SSID, denoted HASH_SSID_{—}4(STA) (block 827). HASH_SSID_{—}4(STA) may be generated from the SSID used in generating HASH_SSID_{—}1(STA) which resulted in the match with HASH_SSID_{—}1(AP), as well as HASH_SSID_{—}2(STA) and HASH_SSID_{—}3(STA). In other words, the SSID of the AP. Prior to hashing, the STA may use a value to modify the SSID, e.g., a Nonce, to help prevent a static hash from occurring. The STA may send an Association Request frame including the HASH_SSID_{—}4(STA) to the AP (block 829). The STA may include the value used to modify the SSID in the Association Request frame so that the AP will be able to recreate the truncated hashed SSID. If the AP verified the SSID used by the STA with its own SSID, the STA may receive an Association Response frame from the AP with a Status Code set to SUCCESS (block 831).

The truncated hashed SSIDs may be sent from the STA to the AP or from the AP to the STA in a Hashed SSID IE configured as described previously. Alternatively, the truncated hashed SSIDs may be sent from the STA to the AP or from the AP to the STA in a legacy SSID IE configured as described previously.

FIG. 8b illustrates a flow diagram of example operations 850 occurring in an AP as a STA connects to the AP using a combination of passive and active scanning procedures. Operations 850 may be indicative of operations occurring in an AP, such as such as AP 105, as a STA, such as STAs 110-118, connects to the AP using a combination of passive and active scanning procedures.

Operations 850 may begin with the AP generating a first truncated hashed SSID, denoted HASH_SSID_{—}1(AP) (block 855). HASH_SSID_{—}1(AP) may be generated from the SSID of the AP. The SSID of the AP may be modified with a value, such as a timestamp, a frame type, a frame sequence number, and the like. The AP may transmit a Beacon frame including the HASH_SSID_{—}1(AP) (block 857). The Beacon frame may include the value used to modify the SSID so that the STA will be able to recreate the truncated hashed SSID. The AP may receive a Probe Request frame from the STA that includes a second truncated hashed SSID, denoted HASH_SSID_{—}2(STA) (block 859). The AP may generate its own second truncated hashed SSID, denoted HASH_SSID_{—}2(AP) (block 861). HASH_SSID_{—}2(AP) may be generated from the SSID of the AP. The SSID of the AP may be modified by a value in the Probe Request, e.g., a Nonce, prior to hashing.

The AP may perform a check to determine if HASH_SSID_{—}2(AP) is equal to HASH_SSID_{—}2(STA) (block 863). If HASH_SSID_{—}2(AP) is not equal to HASH_SSID_{—}2(STA), then operations 850 may end since the SSID of the AP does not match with the SSID of a WLAN that the STA is attempting to connect with. If HASH_SSID_{—}2(AP) is equal to HASH_SSID_{—}2(STA), the AP may generate a third truncated hashed SSID, denoted HASH_SSID_{—}3(AP) (block 865). HASH_SSID_{—}4(AP) may be generated from the SSID of the AP. The SSID of the AP may be modified with a value, such as a timestamp, a frame type, a frame sequence number, and the like, prior to hashing. The AP may send a Probe Response frame including HASH_SSID_{—}3(AP) to the STA (block 867). The Probe Response frame may include the value used to modify the SSID so that the STA will be able to recreate the truncated hashed SSID.

The AP may receive an Authentication Request frame from the STA (block 869) and send an Authentication Response frame to the STA (block 871). The AP may receive an Association Request frame including a fourth truncated hashed SSID, denoted HASH_SSID_{—}4(STA) (block 873). The AP may generate a fourth truncated hashed SSID, denoted HASH_SSID_{—}4(AP) (block 875). HASH_SSID_{—}4(AP) may be generated from the SSID of the AP. The AP may use a value in the Association Request frame to modify the SSID, e.g., a Nonce, prior to hashing. The AP may perform a check to determine if HASH_SSID_{—}4(AP) is equal to HASH_SSID_{—}4(STA) (block 877). If HASH_SSID_{—}4(AP) is not equal to HASH_SSID_{—}4(STA), then operations 850 may terminate since the SSIDs to not match. If HASH_SSID_{—}4(AP) is equal to HASH_SSID_{—}4(STA), the AP may generate an Association Response frame with a Status Code set to SUCCESS (block 879). The AP may send the Association Response frame to the STA (block 881).

The truncated hashed SSIDs may be sent from the STA to the AP or from the AP to the STA in a Hashed SSID IE configured as described previously. Alternatively, the truncated hashed SSIDs may be sent from the STA to the AP or from the AP to the STA in a legacy SSID IE configured as described previously.

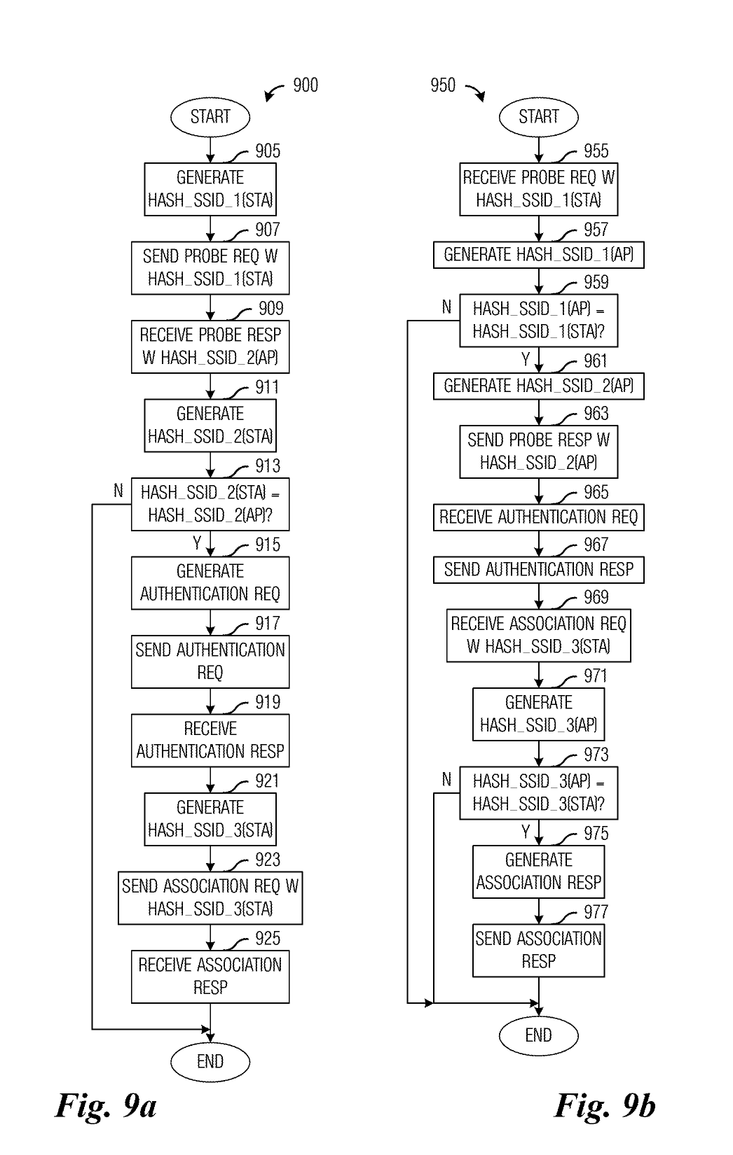

FIG. 9a illustrates a flow diagram of example operations 900 occurring in a STA as the STA connects to an AP using an active scanning procedure. Operations 900 may be indicative of operations occurring in a STA, such as STAs 110-118, as the STA connects to an AP, such as such as AP 105, using an active scanning procedure.

Operations 900 may begin with the STA generating a first truncated hashed SSID, denoted HASH_SSID_{—}1(STA) (block 905). HASH_SSID_{—}1(STA) may be generated using the SSID of an AP, which the STA has stored before and is searching for at the moment. The STA may modify the SSID with a value, e.g., a Nonce. The STA may transmit a Probe Request frame including HASH_SSID_{—}1(STA) to the AP (block 907). The Probe Request frame may include the value used to modify the SSID so that the AP will be able to recreate the truncated hashed SSID.

The STA may receive a Probe Response frame from the AP that includes a second truncated hashed SSID, denoted HASH_SSID_{—}2(AP) (block 909). The STA may generate its own second truncated hashed SSID, denoted HASH_SSID_{—}2(STA) (block 911). The HASH_SSID_{—}2(STA) may be generated using the SSID used to generate HASH_SSID_{—}1(STA). The STA may modify the SSID with a value in the Probe Response frame, e.g., a timestamp, a frame type, a frame sequence number, and the like, which is also used by the AP to generate HASH_SSID_{—}2(AP).

The STA may perform a check to determine if HASH_SSID_{—}2(STA) is equal to HASH_SSID_{—}2(AP) (block 913). If HASH_SSID_{—}2(STA) is not equal to HASH_SSID_{—}2(AP), then operations 900 may end since the SSIDs do not match. If HASH_SSID_{—}2(STA) is equal to HASH_SSID_{—}2(AP), the STA may generate an Authentication Request frame (block 915) and send the Authentication Request frame to the AP (block 917). The STA may receive an Authentication Response frame (block 919).

The STA may generate a third truncated hashed SSID, denoted HASH_SSID_{—}3(STA) (block 921). HASH_SSID_{—}3(STA) may be generated from the SSID used in generating HASH_SSID_{—}1(STA) which resulted in the match with HASH_SSID_{—}1(AP), as well as HASH_SSID_{—}2(STA). In other words, the SSID of the AP. The STA may use a value to modify the SSID, e.g., a Nonce, to help prevent a static hash from occurring. The STA may send an Association Request frame including the HASH_SSID_{—}3(STA) to the AP (block 923). The STA may include the value used to modify the SSID in the Association Request frame so that the AP will be able to recreate the truncated hashed SSID. If the AP verified the SSID used by the STA with its own SSID, the STA may receive an Association Response frame from the AP with a Status Code set to SUCCESS (block 925).

The truncated hashed SSIDs may be sent from the STA to the AP or from the AP to the STA in a Hashed SSID IE configured as described previously. Alternatively, the truncated hashed SSIDs may be sent from the STA to the AP or from the AP to the STA in a legacy SSID IE configured as described previously.

FIG. 9b illustrates a flow diagram of example operations 950 occurring in an AP as a STA connects to the AP using an active scanning procedure. Operations 950 may be indicative of operations occurring in an AP, such as such as AP 105, as a STA, such as STAs 110-118, connects to the AP using an active scanning procedure.

Operations 950 may begin with the AP receiving a Probe Request frame from the STA that includes a first truncated hashed SSID, denoted HASH_SSID_{—}1(STA) (block 955). The AP may generate its own first truncated hashed SSID, denoted HASH_SSID_{—}1(AP) (block 957). HASH_SSID_{—}1(AP) may be generated from the SSID of the AP. prior to hashing, the SSID of the AP may be modified by a value in the Probe Request frame, e.g., a Nonce, which is also used by the STA to generate HASH_SSID_{—}1(STA).

The AP may perform a check to determine if HASH_SSID_{—}1(AP) is equal to HASH_SSID_{—}1(STA) (block 959). If HASH_SSID_{—}1(AP) is not equal to HASH_SSID_{—}1(STA), then operations 950 may end since the SSID of the AP does not match with the SSID of a WLAN that the STA is attempting to connect with. If HASH_SSID_{—}1(AP) is equal to HASH_SSID_{—}1(STA), the AP may generate a second truncated hashed SSID, denoted HASH_SSID_{—}2(AP) (block 961). HASH_SSID_{—}2(AP) may be generated from the SSID of the AP. The SSID of the AP may be modified with a value, such as a timestamp, a frame type, a frame sequence number, and the like, prior to hashing. The AP may send a Probe Response frame including HASH_SSID_{—}2(AP) to the STA (block 963). The Probe Response frame may include the value used to modify the SSID so that the STA will be able to recreate the truncated hashed SSID.

The AP may receive an Authentication Request frame from the STA (block 965) and send an Authentication Response frame to the STA (block 967). The AP may receive an Association Request frame including a third truncated hashed SSID, denoted HASH_SSID_{—}3(STA) (block 969). The AP may generate a third truncated hashed SSID, denoted HASH_SSID_{—}3(AP) (block 971). HASH_SSID_{—}3(AP) may be generated from the SSID of the AP. The AP may use a value in the Association Request frame to modify the SSID, e.g., a Nonce, prior to hashing. The AP may perform a check to determine if HASH_SSID_{—}3(AP) is equal to HASH_SSID_{—}3STA) (block 973). If HASH_SSID_{—}3(AP) is not equal to HASH_SSID_{—}3(STA), then operations 950 may terminate since the SSIDs to not match. If HASH_SSID_{—}3(AP) is equal to HASH_SSID_{—}3(STA), the AP may generate an Association Response frame with a Status Code set to SUCCESS (block 975). The AP may send the Association Response frame to the STA (block 977).

The truncated hashed SSIDs may be sent from the STA to the AP or from the AP to the STA in a Hashed SSID IE configured as described previously. Alternatively, the truncated hashed SSIDs may be sent from the STA to the AP or from the AP to the STA in a legacy SSID IE configured as described previously.

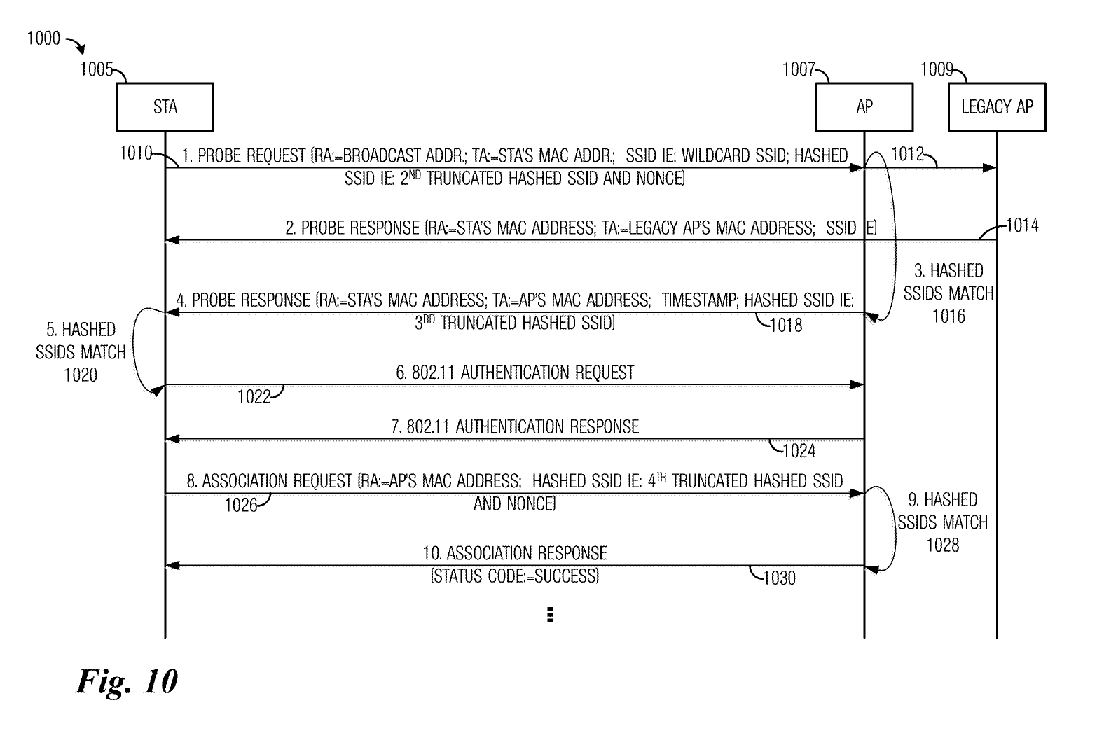

FIG. 10 illustrates a message exchange diagram 1000 of example messages exchanged between a STA, an AP, and a legacy AP as the STA connects with the AP. Message exchange diagram 1000 illustrates example messages exchanged between a STA 1005, an AP 1007, and a legacy AP 1009, as well as operations performed by STA 1005 and AP 1007. Message exchange diagram 1000 may begin with STA 1000 sending a Probe Request frame (shown as event 1010) including a first hashed SSID that the STA has stored before and is search for at the moment. Since STA 1005 is hashed SSID compliant and knows (or thinks that it knows) the SSID of hashed SSID compliant AP 1007, but not the MAC address of AP 1007 (which may be a typical scenario when using WLAN in a public area, such as an airport lounge, for example), STA 1005 may broadcast the Probe Request frame. To AP 1009, which is not hashed SSID compliant, the Probe Request frame has the appearance of a Wildcard Probe Response frame and AP 1009 may respond with a Probe Response frame (shown as event 1014). For discussion purposes, assume that STA 1005 is not interested in the Probe Response frame sent by AP 1009 since AP 1009 is not hashed SSID compliant, thereby terminating the message exchange between STA 1005 and AP 1009. To AP 1007, the Probe Request frame has the appearance of a dedicated Probe Request frame (due to the presence of the first hashed SSID). Therefore, AP 1007 does not respond with a Probe Response frame unless a first hashed SSID (or truncated hashed SSID) generated by AP 1007 matches with the first hashed SSID included in the Probe Request frame (shown as events 1016 and 1018). If the two first hashed SSIDs match, AP 1007 generates a second hashed SSID from the SSID associated with the AP and sends a Probe Response frame including the second hashed SSID to STA 1005.

STA 1005 may respond to the Probe Response frame from AP 1007 by performing a check to determine if a second hashed SSID that STA 1005 generates matches the second hashed SSID included in the Probe Response frame (shown as event 1020). If the two second hashed SSIDs match, STA 1005 may send an IEEE 802.11 Authentication Request frame (shown as event 1022) and AP 1007 may send an IEEE 802.11 Authentication Response frame (shown as event 1024). STA 1005 may continue the message exchange with an Association Request frame that includes a third hashed SSID generated with the SSID that matches with the one of AP 1007 (shown as event 1026). AP 1007 may check to determine if a third hashed SSID that AP 1007 generates matches the third hashed SSID included in the Association Request frame (shown as event 1028). If the two third hashed SSIDs match, AP 1007 may respond with an Association Response frame that includes a Status Code set to SUCCESS (shown as event 1030). The example messages exchanged between STA 1005 and AP 1007 (and an authentication server) may also include messages involved in EAP/802.1X/Radius authentication, a 4-way handshake, and secured data communications.

Aspects of this disclosure also provide techniques for maintaining backward compatibility. An example embodiment technique is described as follows: When an AP, capable of Hashed SSID operation, transmits a Beacon frame with the Hashed SSID IE, such as event 610 in FIG. 6, it may include a legacy SSID IE with the null SSID. A legacy STA may see the AP as an AP with hidden SSID enabled. Then the legacy STA may check the MAC address of the AP to see if it belongs to one of its preferred AP. If not, the legacy STA will ignore the AP. It may not be advantageous to send both Hashed SSID and the plain text full SSID simultaneously. A reason to include a null SSID in the legacy SSID IE here is to avoid otherwise possible erroneous behavior of an implementation of a legacy STA if it sees a Beacon frame without an SSID IE at all. When a STA, capable of Hashed SSID operation, transmits an Association or Reassociation Request frame with the Hashed SSID IE, such as event 626 of FIG. 6, it may remove the legacy SSID IE entirely from the Request as it already has the AP's MAC address thus may set the RA field in the Request frame to the AP's MAC address. A legacy AP will ignore the Request frame as the RA field doesn't match for it.

Another example embodiment is described as follows: When a STA, capable of Hashed SSID operation, transmits a Probe Request frame with the Hashed SSID IE, if the STA already knows the MAC address of the Hashed-SSID-capable AP, e.g., after receiving the Beacon frame from the AP in event 610 of FIG. 6 or after the user manually types in the MAC address of the AP, then the STA may use that the AP's MAC address as the RA in the Probe Request frame (effectively making it a unicast Probe Request frame) and remove the legacy SSID IE entirely. Such an example is shown in event 614 of FIG. 6. A legacy AP will ignore the Probe Request frame as the RA field doesn't match (i.e., the RA is not its MAC address nor the broadcast MAC address) for it.

If the STA doesn't know the MAC address of the Hashed-SSID-capable AP, e.g., only the SSID of the AP is provided to an user after the user purchases temporary usage to a fee-bearing WLAN, then the STA may also include a legacy SSID IE with a Wildcard SSID, which appears the same as a null SSID, in the Probe Request. Such an example is shown in event 1010 of FIG. 10. The legacy SSID IE is included here to avoid otherwise possible erroneous behavior of an implementation of a legacy AP if it sees a Probe Request frame without an SSID IE at all. But, this Probe Request frame, appearing as a Wildcard Probe Request to legacy APs, may cause legacy APs nearby to respond, as shown in Step 2 in FIG. 7. However, at least they don't misbehave from a protocol standpoint.

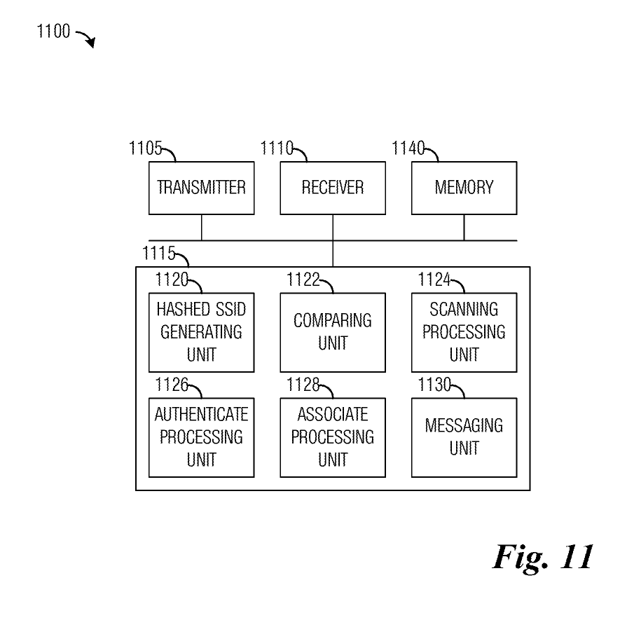

FIG. 11 illustrates an example communications device 1100. Communications device 1100 may be an implementation of a hashed SSID compliant communications device, such as a communications controller, such as an access point, an eNB, a base station, a NodeB, a controller, and the like, or a device, such as a station, a UE, a user, a subscriber, a terminal, a mobile, a mobile station, and the like. Communications device 1100 may be used to implement various ones of the embodiments discussed herein. As shown in FIG. 11, a transmitter 1105 is configured to transmit data frames, control frames including hashed SSIDs, and the like. Communications device 1100 also includes a receiver 1110 that is configured to receive data frames, control frames including hashed SSIDs, and the like.

A hashed SSID generating unit 1120 is configured to generate a hashed SSID (or a truncated hashed SSID) from a SSID. Hashed SSID generating unit 1120 is configured to use a hashing function, such as SHA-256. Hashed SSID generating unit 1120 is configured to modify the SSID using a value, such as a timestamp, a frame type, a frame sequence number, a Nonce, a MAC address, and the like, prior to hashing. Hashed SSID generating unit 1120 is configured to combine, e.g., combine, add, and the like, the value with the SSID. Hashed SSID generating unit 1120 is configured to truncate the hashed SSID to produce truncated hashed SSIDs. A comparing unit 1122 is configured to compare two hashed SSIDs (or truncated hashed SSIDs) and indicate if the two hashed SSIDs are or are not equal. A scanning processing unit 1124 is configured to generate messaging used in a scanning procedure. Scanning processing unit 1124 is configured to generate Beacon frames, Probe Request frames, and/or Probe Response frames. Scanning processing unit 1124 is configured to process messaging used in a scanning procedure. Scanning processing unit 1124 is configured to process Beacon frames, Probe Request frames, and/or Probe Response frames.

An authenticate processing unit 1126 is configured to generate messaging used in an authentication procedure. Authenticate processing unit 1126 is configured to generate Authentication Request frames and/or Authentication Response frames. Authenticate processing unit 1126 is configured to process Authentication Request frames and/or Authentication Response frames. An associate processing unit 1128 is configured to generate messaging used in an association procedure. Associate processing unit 1128 is configured to generate Association Request frames and/or Association Response frames. Associate processing unit 1128 is configured to process Association Request frames and/or Association Response frames. A messaging unit 1130 is configured to generate frames. Messaging unit 1130 is configured to generate frames with a hashed SSID IE containing a hashed SSID. Messaging unit 1130 is configured to generate frames with a legacy SSID IE containing a hashed SSID or containing a hashed SSID and a pre-defined value that indicates the legacy SSID IE actually contains a hashed SSID. A memory 1140 is configured to store SSIDs, preferred WLAN lists, hashed SSIDs, values for modifying SSIDs (e.g., timestamps, frame types, frame sequence numbers, Nonces), data frames, control frames, and the like.

The elements of communications device 1100 may be implemented as specific hardware logic blocks. In an alternative, the elements of communications device 1100 may be implemented as software executing in a processor, controller, application specific integrated circuit, or so on. In yet another alternative, the elements of communications device 1100 may be implemented as a combination of software and/or hardware.

As an example, receiver 1110 and transmitter 1105 may be implemented as a specific hardware block, while hashed SSID generating unit 1120, comparing unit 1122, scanning processing unit 1124, authenticate processing unit 1126, associate processing unit 1128, and messaging unit 1130 may be software modules executing in a microprocessor (such as processor 1115) or a custom circuit or a custom compiled logic array of a field programmable logic array. Hashed SSID generating unit 1120, comparing unit 1122, scanning processing unit 1124, authenticate processing unit 1126, associate processing unit 1128, and messaging unit 1130 may be modules stored in memory 1140.

Aspects of this disclosure provide the following benefits: Protecting SSID privacy; Protecting user privacy (such as location, interests, etc.); Making it more costly for an attacker to impersonate a legitimate AP or STA; Maintaining backward compatibility such that legacy STAs or legacy APs don't misbehave when a Hashed SSID is used; and the like. Aspects of this disclosure may be effectuated without significantly departing from existing telecom standards.

Although the present disclosure and its advantages have been described in detail, it should be understood that various changes, substitutions and alterations can be made herein without departing from the spirit and scope of the disclosure as defined by the appended claims.

What is claimed is:

1. A method for securing communications between an access point and a station, the method comprising:
generating, by the station, a first hashed service set identifier (SSID) by applying a first hash function to a first SSID known by the station;
transmitting, by the station, a first message to the access point, wherein the first message includes the first hashed SSID;
receiving, by the station, a second message from the access point, wherein the second message includes a second hashed SSID generated by the access point by applying a second hash function to a second SSID associated with the access point;
generating, by the station, a third hashed SSID by applying the second hash function to the first SSID;
determining, by the station, if the third hashed SSID matches the second hashed SSID; and
transmitting, by the station, a third message to the access point if the third hashed SSID matches the second hashed SSID.

2. The method of claim 1, wherein generating the first hashed SSID comprises:
obtaining a first value comprising one or more of a time stamp, a value associated with a frame type of a frame that carries the first message, a nonce, a sequence number, and a medium access control (MAC) address;
modifying the first SSID with the first value to obtain a first modified SSID to be used as an input to the first hash function;
generating a first hash output by applying the first hash function to the first modified SSID; and
truncating the first hash output with a first truncation function to produce the first hashed SSID.

3. The method of claim 1, wherein generating the third hashed SSID comprises:
retrieving a second value from the second message, the second value comprising one or more of a time stamp, a value associated with a frame type of a frame that carries the second message, a nonce, a sequence number, and a MAC address;
modifying the first SSID with the second value to obtain a second modified SSID to be used as an input to the second hash function;
generating a second hash output by applying the second hash function to the second modified SSID; and
truncating the second hash output with a second truncation function to produce the third hashed SSID.

4. The method of claim 1, wherein the first message is a Probe Request frame, the second message is a Probe Response frame, and the third message is an Authentication Request frame.

5. The method of claim 1, further comprising prior to transmitting the first message:
receiving a fourth message from the access point, wherein the fourth message includes a fourth hashed SSID generated by the access point by applying a third hash function to the second SSID;
generating a fifth hashed SSID by applying the third hash function to the first SSID; and
determining if the fifth hashed SSID matches the fourth hashed SSID.

6. The method of claim 5, wherein generating the fifth hashed SSID comprises:
retrieving a third value from the fourth message, the third value comprising one or more of a time stamp, a value associated with a frame type of a frame that carries the fourth message, a nonce, a sequence number, and a MAC address;
modifying the first SSID with the third value to obtain a third modified SSID to be used as an input to the third hash function;
generating a third hash output by applying the third hash function to the third modified SSID; and
truncating the third hash output with a third truncation function to produce the fifth hashed SSID.

7. The method of claim 5, wherein generating the first hashed SSID, transmitting the first message, receiving the second message, generating the third hashed SSID, determining if the third hashed SSID matches the second hashed SSID, and transmitting the third message occurs only if the fifth hashed SSID matches the fourth hashed SSID.

8. The method of claim 5, wherein the fourth message comprises a Beacon frame.

9. The method of claim 1, wherein the first message includes a hashed SSID Information Element (IE) containing the first hashed SSID in a hashed SSID field.

10. The method of claim 1, wherein the first message includes a legacy SSID IE including a SSID field comprising the first hashed SSID and a Length field set to a first pre-specified value indicating that the SSID field comprises the first hashed SSID.

11. The method of claim 10, wherein the SSID field further includes a second pre-specified value in a first portion of the SSID field, the second pre-specified value being one of a specified text string, a specified value, and a specified sequence, wherein the second pre-specified value indicates that the SSID field includes the first hashed SSID in a second portion of the SSID field, and wherein the first pre-specified value equal to a sum of a length of the first hashed SSID and a length of the second pre-specified value.

12. The method of claim 1, wherein the first hash function and the second hash function are equal.

13. A method for securing communications between an access point and a station, the method comprising:
receiving, by the station, a first message from the access point, wherein the first message includes a first hashed service set identifier (SSID) generated by applying a first hash function to a first SSID associated with the access point;
generating, by the station, a second hashed SSID by applying the first hash function to a second SSID known by the station;
determining, by the station, if the second hashed SSID matches the first hashed SSID; and
transmitting, by the station, a second message to the access point if the second hashed SSID matches the first hashed SSID.

14. The method of claim 13, wherein the first message is a Beacon frame, and the second message is an Authentication Request frame.

15. The method of claim 13, wherein the first message comprises a hashed SSID Information Element (IE) including the first hashed SSID in a hashed SSID field.

16. The method of claim 13, wherein the first message comprises a legacy SSID IE with a SSID field comprising the first hashed SSID and a Length field set to a pre-specified value indicating that the SSID field comprises the first hashed SSID.

17. A method for securing communications between an access point and a station, the method comprising:
generating, by the access point, a first hashed service set identifier (SSID) by applying a first hash function to a first SSID associated with the access point;
transmitting, by the access point, a Beacon frame to the station, wherein the Beacon frame includes the first hashed SSID;
receiving, by the access point, a first message from the station; and
transmitting, by the access point, a second message to the station, wherein the second message is responsive to the first message.

18. The method of claim 17, wherein generating the first hashed SSID comprises:
obtaining a first value comprising one or more of a time stamp, a value associated with a frame type of the Beacon frame, a nonce, a sequence number, and a medium access control (MAC) address;
modifying the first SSID with the first value to obtain a first modified SSID to be used as an input to the first hash function;
generating a first hash output by applying the first hash function to the first modified SSID; and
truncating the first hash output with a first truncation function to produce the first hashed SSID.

19. The method of claim 17, further comprising:
receiving a third message from the station, wherein the third message includes a second hashed SSID generated by the station by applying a second hash function to a second SSID known by the station;
generating a third hashed SSID by applying the second hash function to the first SSID;
determining if the third hashed SSID matches the second hashed SSID; and
transmitting a fourth message to the station if the third hashed SSID matches the second hashed SSID.

20. The method of claim 19, wherein generating the third hashed SSID comprises:
retrieving a second value from the third message, the second value comprising one or more of a time stamp, a value associated with a frame type of a frame that carries the third message, a nonce, a sequence number, and a MAC address;
modifying the first SSID with the second value to obtain a second modified SSID to be used as an input to the second hash function;
generating a second hash output by applying the second hash function to the second modified SSID; and
truncating the second hash output with a second truncation function to produce the third hashed SSID.

21. The method of claim 20, wherein the third message is an Association Request frame, the fourth message is an Association Response frame including a Status Code set to SUCCESS, and wherein receiving the third message and transmitting the fourth message occurs after transmitting the second message.

22. The method of claim 20, further comprising generating a fourth hashed SSID by applying a third hash function to the first SSID if the third hashed SSID matches the second hashed SSID, wherein generating the fourth hashed SSID comprises:
obtaining a third value comprising one or more of a time stamp, a value associated with a frame type of a frame that carries the fourth message, a nonce, a sequence number, and a MAC address;
modifying the first SSID with the third value to obtain a third modified SSID to be used as an input to a third hash function;
generating a third hash output by applying the third hash function to the third modified SSID; and
truncating the third hash output with a third truncation function to produce the fourth hashed SSID, wherein the third message is a Probe Request frame, the fourth message is a Probe Response frame including the fourth hashed SSID, and wherein receiving the third message and transmitting the fourth message occurs prior to receiving the first message.

23. The method of claim 17, wherein the first message is an Authentication Request frame, and the second message is an Authentication Response frame.

24. A station comprising:
a processor configured to generate a first hashed service set identifier (SSID) by applying a first hash function to a first SSID known by the station, to generate a third hashed SSID by applying a second hash function to the first SSID, and to determine if the third hashed SSID matches a second hashed SSID generated by an access point by applying the second hash function to a second SSID associated with the access point;
a transmitter operatively coupled to the processor, the transmitter configured to transmit a first message to the access point, wherein the first message includes the first hashed SSID, and to transmit a third message to the access point if the third hashed SSID matches the second hashed SSID; and
a receiver operatively coupled to the processor, the receiver configured to receive a second message from the access point, wherein the second message includes the second hashed SSID.

25. The station of claim 24, wherein the processor is configured to obtain a first value comprising one or more of a time stamp, a value associated with a frame type of a frame that carries the first message, a nonce, a sequence number, and a medium access control (MAC) address, to modify the first SSID with the first value to obtain a first modified SSID to be used as an input to the first hash function, to generate a first hash output by applying the first hash function to the first modified SSID, and to truncate the first hash output with a first truncation function to produce the first hashed SSID.

26. The station of claim 24, wherein the processor is configured to retrieve a second value from the second message, the second value comprising one or more of a time stamp, a value associated with a frame type of a frame that carries the second message, a nonce, a sequence number, and a MAC address, to modify the first SSID with the second value to obtain a second modified SSID to be used as an input to the second hash function, to generate a second hash output by applying the second hash function to the second modified SSID, and to truncate the second hash output with a second truncation function to produce the third hashed SSID.

27. The station of claim 24, wherein the receiver is configured to receive a fourth message from the access point, wherein the fourth message includes a fourth hashed SSID generated by the access point by applying a third hash function to the second SSID, and wherein the processor is configured to generate a fifth hashed SSID by applying the third hash function to the first SSID and to determine if the fifth hashed SSID matches the fourth hashed SSID.

28. The station of claim 27, wherein the processor is configured to retrieve a third value from the fourth message, the third value comprising one or more of a time stamp, a value associated with a frame type of a frame that carries the fourth message, a nonce, a sequence number, and a MAC address, to modify the first SSID with the third value to obtain a third modified SSID to be used as an input to the third hash function, to generate a third hash output by applying the third hash function to the third modified SSID, and to truncate the third hash output with a third truncation function to produce the fifth hashed SSID.

29. The station of claim 24, wherein the first message includes a hashed SSID Information Element (IE) containing the first hashed SSID in a hashed SSID field.

30. The station of claim 24, wherein the first message includes a legacy SSID IE including a SSID field comprising the first hashed SSID and a Length field set to a first pre-specified value indicating that the SSID field comprises the first hashed SSID.

31. An access point comprising:
a processor configured to generate a first hashed service set identifier (SSID) by applying a first hash function to a first SSID associated with the access point;
a transmitter operatively coupled to the processor, the transmitter configured to transmit a Beacon frame to a station, wherein the Beacon frame includes the first hashed SSID, and to transmit a second message to the station, wherein the second message is responsive to a first message from the station; and
a receiver operatively coupled to the processor, the receiver configured to receive the first message.

32. The access point of claim 31, wherein the processor is configured to obtain a first value comprising one or more of a time stamp, a value associated with a frame type of the Beacon frame, a nonce, a sequence number, and a medium access control (MAC) address, to modify the first SSID with the first value to obtain a first modified SSID to be used as an input to the first hash function, to generate a first hash output by applying the first hash function to the first modified SSID, and to truncate the first hash output with a first truncation function to produce the first hashed SSID.

33. The access point of claim 31, wherein the receiver is configured to receive a third message from the station, wherein the third message includes a second hashed SSID generated by the station by applying a second hash function to a second SSID known by the station, wherein the processor is configured to generate a third hashed SSID by applying the second hash function to the first SSID, and to determine if the third hashed SSID matches the second hashed SSID, and wherein the transmitter is configured to transmit a fourth message to the station if the third hashed SSID matches the second hashed SSID.

34. The access point of claim 33, wherein the processor is configured to retrieve a second value from the third message, the second value comprising one or more of a time stamp, a value associated with a frame type of a frame that carries the third message, a nonce, a sequence number, and a MAC address, to modify the first SSID with the second value to obtain a second modified SSID to be used as an input to the second hash function, to generate a second hash output by applying the second hash function to the second modified SSID, and to truncate the second hash output with a second truncation function to produce the third hashed SSID.

35. The access point of claim 34, wherein the processor is configured to obtain a third value comprising one or more of a time stamp, a value associated with a frame type of a frame that carries the fourth message, a nonce, a sequence number, and a MAC address, to modify the first SSID with the third value to obtain a third modified SSID to be used as an input to a third hash function, to generate a third hash output by applying the third hash function to the third modified SSID, and to truncate the third hash output with a third truncation function to produce a fourth hashed SSID, wherein the third message is a Probe Request frame, the fourth message is a Probe Response frame including the fourth hashed SSID, and wherein receiving the third message and transmitting the fourth message occurs prior to receiving the first message.

36. A communications system comprising:
an access point configured to serve stations operating within a coverage area; and
a station operatively coupled to the access point, the station configured to generate a first hashed service set identifier (SSID) by applying a first hash function to a first SSID known by the station, to transmit a first message to the access point, wherein the first message includes the first hashed SSID, to receive a second message from the access point, wherein the second message includes a second hashed SSID generated by the access point by applying a second hash function to a second SSID associated with the access point, to generate a third hashed SSID by applying the second hash function to the first SSID, to determine if the third hashed SSID matches the second hashed SSID, and to transmit a third message to the access point if the third hashed SSID matches the second hashed SSID.

37. The communications system of claim 36, wherein the station comprises:
a first processor configured to generate the first hashed service set identifier (SSID) by applying the first hash function to the first SSID known by the station, to generate the third hashed SSID by applying the second hash function to the first SSID, and to determine if the third hashed SSID matches the second hashed SSID generated by the access point by applying the second hash function to the second SSID associated with the access point;
a first transmitter operatively coupled to the first processor, the first transmitter configured to transmit the first message to the access point, wherein the first message includes the first hashed SSID, and to transmit the third message to the access point if the third hashed SSID matches the second hashed SSID; and
a first receiver operatively coupled to the first processor, the first receiver configured to receive the second message from the access point, wherein the second message includes the second hashed SSID.

38. The communications system of claim 36, wherein the access point is configured to receive the first message from the station, to generate the second hashed SSID, to determine if the first hashed SSID matches the second hashed SSID, to transmit the second message to the station if the first hashed SSID matches the second hashed SSID, wherein the second message includes the second hashed SSID, and to receive the third message from the station.

39. The communications system of claim 38, wherein the access point comprises:
a second receiver configured to receive the first message from the station, and to receive the third message from the station;
a second processor operatively coupled to the receiver, the second processor configured to generate the second hashed SSID by applying the first hash function to the second SSID, and to determine if the first hashed SSID matches the second hashed SSID; and
a second transmitter operatively coupled to the second processor, the second transmitter configured to transmit the second message to the station if the first hashed SSID matches the second hashed SSID.
